(19) United States
(12) Patent Application Publication
(10) Pub. No.: US 2021/0117574 A1
(43) Pub. Date: Apr. 22, 2021

(54) DATA PRIVACY IN ONLINE AND PHYSICAL WORLD ENVIRONMENTS

(71) Applicant: e2Post, Inc., Hacienda Heights, CA (US)

(72) Inventor: Kenton Abel, Hacienda Heights, CA (US)

(73) Assignee: e2Post, Inc., Hacienda Heights, CA (US)

(21) Appl. No.: 17/110,240

(22) Filed: Dec. 2, 2020

Related U.S. Application Data
(63) Continuation-in-part of application No. 13/049,873, filed on Mar. 16, 2011.
(60) Provisional application No. 61/314,578, filed on Mar. 16, 2010.

(51) Int. Cl. G06F 21/62; H04L 29/06; G06F 16/951

(52) U.S. Cl. CPC G06F 21/6263; G07B 17/00; G06F 16/951; H04L 63/0421

(57) ABSTRACT

Systems, methods, and articles of manufacture for protecting personal data in digital and physical worlds in which the personal data of a networked computing system is used for physical world communications. Preauthorized permissions or rules of a computing system specify how personal data of a first user, as a user that will receive a mailer, can be used by a different, second user to communicate with the first user in the physical world by sending the first user a mailer. The mailer may be a greeting card is generated and includes personal data (such as recipient name and address) to be sent to the receiving user, but the sender is not provided with the receiving user's personal data such that the sending user may not know the receiving user's address or even the receiving user's real name.

### CROSS-REFERENCE TO RELATED APPLICATIONS

This application is a continuation-in-part of co-pending U.S. Application Serial No. 13/049,873 filed on Mar. 16, 2011, entitled System and Method of Generating Mailers From Online Interactions, which claims the benefit and priority of U.S. Provisional Application No. 61/314,578, filed on Mar. 16, 2010, the contents of all of which are hereby incorporated by reference as though set forth in full.

### FIELD OF THE INVENTION

Embodiments relate to networked computing and database systems, and more particularly, to personal data privacy in online and physical world environments.

### BACKGROUND

Online computing applications for work and entertainment are more popular and necessary today than ever, particularly with people seemingly tied to their computing devices and working from home more often. Hundreds of millions of users connect with each other each day in various on-line computing environments.

Some users may know each other and connect with each other personally in online applications and in the real world. In other cases, friends or contacts connect with each other in the real world but may not know where they live. For example, in an office environment, co-workers may know each other by name but may not know where each other lives, and a co-worker may desire to maintain that personal data as private. As another example, users may be “virtual” friends and connect with each other online such as in an on-line game, but virtual friends may never meet in real life. Instead, game players often know each other by fictitious user names and may live in different cities, states and countries. In these “disconnected” virtual environments such as on-line gaming environments, users may want to maintain anonymity and not disclose to other users their real names or where they live. Instead, they want to only be identified by their username with a protective mask of anonymity. Similar privacy concerns arise in other online applications such as on-line dating, in which one user may not want another user to know their full name, real name or physical residence.

These personal data privacy concerns also exist in communications between people both in online and real world or physical world environments. For example, in order to send an object such as a letter or gift to another person, the sender must know the real name and mailing address of the recipient in order for the object to be mailed and delivered. However, these are the very types of personal information that people want to maintain as private. A result of maintaining privacy is a decrease in the ability to receive physical correspondence and/or gifts from online connections, whereas sharing personal information in order to receive physical letters or gifts will decrease privacy.

Thus, while different online applications and environments involve different degrees of online and physical world connectivity and interaction, they involve similar challenges in maintaining privacy of personal or sensitive user data, user safety, and identity theft. These concerns are more pronounced in an increasingly connected world. Accordingly, it will be appreciated that there exists a need for improved personal data privacy and a need for improved personal data privacy in both online and physical world environments while also enabling physical communication from online connections.

### SUMMARY

Certain embodiments relate to providing for physical world communications between users of a networked computing system while protecting or maintaining privacy of personal user data that is hosted by the computing system and needed for physical world communications.

Certain embodiments relate to maintaining data privacy and protecting against identity theft by use of preauthorized permissions or rules that specify how certain data in a computing system can be used outside of the computing system in the real or physical world.

Certain embodiments relate to users joining or registering with a networked computing system that provides users with controllable physical world anonymity, which may be complete or partial anonymity, as specified through the networked computing system. Controllable anonymity is used for communications involving computing system users in the physical world.

Certain embodiments relate to generating a physical mailer on behalf of a first user of a computing system to be sent to a different, second user of the computing system in the physical world. Examples of a physical mailer include a greeting card, a post card, and a letter. One user of the computing system provides certain information known about another user. For example, a sender user may provide identification information that is public and previously disclosed by a recipient user such as the recipient user's email address or screen name or user name. That known data is then used to identity other, personal data of the recipient user that is private or sensitive, such as the recipient user's real name and/or residence mailing address. This personal data is then utilized to generate a physical mailer that is sent to the recipient user on behalf of the sending user, but without the sending user having access to or being provided with the recipient user's personal data. The sending user does not even possess and is not provided with the physical mailer that was generated so that the sending user also cannot determine the recipient user's mailing address from the physical mailer.

Certain embodiments relate to providing for the ability to generate and send a physical mailer from one user of a computing system to another user of the computing system when the computing system users may not know each other or even previously met. For example, computing system users may be “virtual friends” such as players of the same online game or users of the same online social network.

Certain embodiments relate to generating a physical mailer addressed to a recipient user of the computing system. The physical mailer includes the recipient user's real name and address, while the recipient user's name and address are not provided to and not known by a sending user that requested that the physical mailer be sent to the recipient user.

Certain embodiments also relate to generating a printed mailer to be sent on behalf of a sending user of the computing system to a recipient user of the computing system while information provided by the sending user to identify the recipient user in the computing system is not printed on the physical mailer. In other words, known identification information provided by the sending user to the computing system is used by the computing system to identify the recipient user and initiate generation of a printed mailer that includes other, personal information besides the known information that was provided by the sending user.

Certain embodiments also relate to generating a physical mailer addressed to a recipient user of the computing system (with the sending user's real name and address), while the recipient user's name address is not provided to and not known by the sending user. The return address on the physical mailer does not include personal data of the sending user (such as the sending user's real name and/or address). Thus, a physical mailer, generated and mailed via a computing system, is sent anonymously on behalf of one user to another user, while personal data of the recipient user that is printed on the physical mailer is neither provided to nor known by the sending user.

Certain embodiments also relate to permission or rule-based mail generation based on personal data and associated preauthorized permissions or rules in a networked computing environment in which a request to generate a physical mail originates within the networked computing environment.

One embodiment is for a computing system that is operable to protect personal data in an on-line computing or digital environment and in a physical world in which the personal data is utilized and may be necessary for physical world communications. According to one embodiment, a computing system comprises a web server including a processor, a memory or data store, a data privacy application, and a database. The web server is in communication with one or more users' computing devices through one or more networks and is also in communication with the database. The data privacy application comprises instructions stored in the memory of the web server and executable by the processor of the web server. The database comprises data structures for users of the data privacy application. The data privacy application is configured or programmed to receive respective personal data of registered users of the data privacy application from user computing devices. According to one embodiment, the personal data is a physical mailing addresses of a user such as a residence mailing address in the physical world. The data privacy application is further configured to store personal data of users to data structures of the database and receive user input of permissions or rules concerning use of the user's personal data by other users of the data privacy application. Data structures are updated with permissions or rules. With permissions or rules, a first user, as a receiving or recipient user, specifies a preauthorized permission or rule for a second user, as a sending user, governing how the first user's personal data hosted by the database can be used by the second user to facilitate communications between the first user and the second user in the physical world. Preauthorized permissions or rules are specified and stored to the database prior to the second user requesting to communicate with the first user in the physical world. The data privacy application is further configured or programmed to receive a request from a computing device of the second user to send a physical mailer to the first user in the physical world. The request includes identification information or information known by the second user that uniquely identifies the first user. In response to the second user's request, the data privacy application is further configured or programmed to identify personal data of the first user associated with or linked to the identification information in a data structure of the database and to identify a preauthorized permission or rule specified by the first user for allowing the second user to communicate with the first user in the physical world using the first user's personal data. The data privacy application is further configured or programmed to retrieve or receive mailer data, wherein the physical mailer is generated based on the mailer data and the determined personal data in accordance with the identified preauthorized permission or rule and sent to the first user. In this manner, the physical mailer is sent to the first user in the physical world without the second user being provided with the first user's personal data. Thus, the privacy of the first user's personal data is maintained in both networked computing system and physical world environments.

Another embodiment is for a computer-implemented method for protecting personal data in an online computing or digital environment and in a physical world in which the personal data is used and may be needed for physical world communications. The computer-implemented method is executed by a data privacy application comprising instructions stored in a memory of a web server and executable by a processor of the web server, which is also in communication with one or more user computing devices through one or more networks. The web server is also in communication with a database. The database includes data structures for users of the data privacy application. The computer-implemented method executed by the data privacy application comprises receiving personal data of users of the data privacy application from the users' computing devices, the personal data including one or more physical mailing addresses of each user in the physical world. The method further comprises storing the users' personal data in the data structures of the database and receiving user input of permissions or rules concerning use of that user's personal data by other users of the data privacy application. The data structures are updated with the permissions or rules. A first user, as a receiving or recipient user, specifies a preauthorized permission or rule governing how a second user, as a sending user, can utilize the first user's personal data hosted by the database and that is used to for physical world communications between the first user and the second user. The preauthorized permission or rule is specified and stored in the database prior to the second user requesting to communicate with the first user in the physical world. The computer-implemented method further comprises receiving a request from the second user's computing device to send a physical mailer to the first user in the physical world, wherein the request includes identification information that uniquely identifies the first user and that is known and provided by the second user, and in response to the second user's request, identifying personal data of the first user associated with the identification information in a data structure of the database and identify a preauthorized permission or rule specified by the first user for allowing the second user to communicate with the first user in the physical world using the personal data, and retrieving or receiving mailer data, wherein the physical mailer is generated based on the mailer data and the first user's personal data in accordance with the identified preauthorized permission or rule input by the first user so that the physical mailer is sent to the first user in the physical world without the second user being provided with the first user's personal data.

Further embodiments are for articles of manufacture or computer program products comprising a computer readable medium comprising non-transitory computer readable media embodying one or more programmed instructions of a data privacy application operable to protect personal data in on-line world and in a physical world in which the personal data is used for physical world communications. The data privacy application comprises instructions stored in a memory of a web server in communication with one or more users' computing devices through one or more networks and in communication with a database comprising data structures for users of the data privacy application, the programmed instructions of the data privacy application being executable by a processor of the web server to receive personal data of users of the data privacy application from the users' computing devices, the personal data including one or more physical mailing addresses of each user in the physical world, store the users' personal data in the data structures of the database, receive user input of permissions or rules concerning use of that user's personal data by other users of the data privacy application, and update the data structures with the permissions or rules, wherein a first user, as a receiving user, specifies a preauthorized permission or rule for a second user, as a sending user, to utilize the first user's personal data hosted by the database, and to allow the second user to communicate with the first user in the physical world. The preauthorized permission or rule was specified and stored in the database prior to the second user requesting to communicate with the first user in the physical world and receive a request from the second user's computing device to send a physical mailer to the first user in the physical world. The request includes identification information that uniquely identifies the first user and that is known and provided by the second user. In response to the second user's request, the data privacy application is further configured or programmed to identify personal data of the first user associated with the identification information in a data structure of the database and identify a preauthorized permission or rule specified by the first user for allowing the second user to communicate with the first user in the physical world using the personal data, and retrieve or receive mailer data, wherein the physical mailer is generated based on the mailer data and the first user's personal data in accordance with the identified preauthorized permission or rule input by the first user so that the physical mailer is sent to the first user in the physical world without the second user being provided with the first user's personal data.

In one or more embodiments, the computing system by the data privacy application transmits data of the physical mailer and the determined personal data of the first user including the physical mailing address of the first user through a network to a printer. The printer transforms the physical mailer data into a physical form by generating the physical mailer based on the received electronic data and the personal data of the first user. The physical mailer is modified by one or more of cutting, scoring or folding the physical mailer to size and/or configuration for an envelope or carrier and is inserted into the envelope or carrier.

System, method and computer program product embodiments may include or involve computing system components that are local components of the computing system or cloud resources accessible via a network. System, method and article of manufacture or computer program product embodiments may also include or involve one or more physical mailer generation and processing components including one or more or all of a printer, and physical mailer modification system (including one or more or all of a cutting device, scoring device, folding device) an insertion system for inserting a mailer, whether modified or not, into an envelope or package, and a postage system.

Further embodiments are for computer-generated interactive user interfaces, elements and structures thereof, and the combinations thereof, and computer-based interactions provided by embodiments for data privacy when communicating with another computing system user in the physical world.

Other embodiments are for a product or physical mailer generated by embodiments.

In one or more embodiments, the data privacy application is programmed or configured to transmit the mailer data and the determined personal data of the first user including the physical mailing address of the first user through a network to a printer. The printer transforms the mailer and personal data into a physical mailer. The printer may be a local printer of the computing system or a remote printer in communication with the computing system, such as at a mailing facility that is closer to the receiving or first user.

In one or more embodiments, the data privacy application processes the physical mailer generated by the printer into another form or structure, e.g., by cutting scoring or folding the physical mailer. The physical mailer, as printed or as structurally modified, may then be inserted into an envelope or package as necessary. For example, an envelope or package may not be required for a postcard.

In one or more embodiments, the data privacy application is operable so that the second or sending user of the physical mailer or other good or package never physically possesses the physical mailer or package that is generated. The data privacy application never provides to the second user the first user's physical address that is applied to the physical mailer. The data privacy application maintains the first user's personal data as secret data that is not disclosed to or accessible by the second user unless such disclosure or access is authorized by the first user.

In one or more embodiments, the data privacy application provides for user-controllable degrees of physical world anonymity for communications requested or initiated in a computing environment but involving and terminating with the user in the physical world. Degrees of anonymity or information provided to another user may apply to the sending and/or receiving user. For example, a sending user may not want to include a real name and/or mailing address in the return address of the physical mailer, and the receiving or recipient user may be open to receiving a physical mailer from the second user but does not provide their real name and/or residence address to the second user.

In one or more embodiments, the personal data of a user includes multiple physical mailing addresses. A first physical address may be a physical address of the first user's residence in the physical world, and the second physical address is an address of the first user's place of employment in the physical world. Thus, preauthorized permission or rule may specify who may send or what may be sent to a particular address. For example, the data privacy application, according to the preauthorized permissions or rules, may be programmed or configured to select a physical address of the first user's place of employment for the physical mailer based on the known information provided by the second user being associated with the first user's place of employment (such as a work email or phone number), else selecting a different physical address for the physical mailer as a default permission or rule.

In one or more embodiments, the first, receiving or recipient user's personal data that is applied to a physical mailer but not disclosed to or provided to the second or sending user is a real name of the first user. Embodiments may involve the first user's real name and/or address. Embodiments may also involve protecting the second user's real name and/or address, and for this purpose, a return address of the computing system host can be used instead. Other types of personal data that may be protected include birthdate data (e.g., for sending birthday cards to co-workers). Thus, it will be understood that while certain embodiments are described with reference to personal data of names and/or addresses, embodiments may be executed or configured to protect privacy of one or multiple types of personal data, and that such privacy protections may be for a receiving and/or sending user.

In one or more embodiments, the data privacy application, may also transmit mailer data to the computing device of the first user. Thus, as an example, the receiving user may receive both a physical greeting card and an electronic version of that greeting card.

In one or more embodiments, the data privacy application may determine how to efficiently generate and ship a physical mailer. For this purpose, the data privacy application may identify a mailing facility such as a local office of the computing system host or a local post office branch that is closer to the receiving user's address than the host address. Thus, rather than ship or coordinate shipping of the physical mailer from the location of the computing system host, the mailer data and associated personal data of the receiving user can be transmitted through a network to a computing device of the local mailing facility, and at this location, the physical mailer is printed or generated and then shipped. Thus, the physical mailer may be printed or generated remotely relative to the computing system and shipped from a location that is closer to the receiving user's residence than the location of the computing system.

In one or more embodiments, the data privacy application is configured to execute different actions or provide different features and levels of privacy protection to users that have registered with the data privacy application compared to those that have not registered. For example, the second or receiving user must be a registered user of the data privacy application in order to request generation of the physical mailer that is to be sent the first user's physical mailing address when that personal data is not known by the second user. The second user is not provided with the receiving first user's physical address. In contrast, a user that is not registered or not logged into data privacy application may still request generation of a physical mailer to be sent to the first user, but to do so, the second or sending user must know the name and address of the first or receiving user. Data privacy application users may register on their own or independently, without knowledge of other users, or one user may invite another user to register. For example, a sending user may invite another user to sign up with the data privacy application when the sending user wants to generate and send a physical mailer to the receiving user but the data privacy application cannot locate the receiving user's personal data (such as physical world address and/or real name) in the database, thus indicating that the receiving user is not registered with data privacy application.

In one or more embodiments, users of the data privacy application are users of the same online application or website such as an on-line game or social networking website. In these embodiments, the known identification information provided by the second or sending user to the data privacy application may be a user name or screen name of the first or receiving user in an on-line game or social networking website or a combination of the game or network and username or screen name. Embodiments may be operable or configured to be accessible through these on-line game or social networking websites such as by clicking an icon or link to be directed to the data privacy application so that while the second or sending user is logged into an on-line game or gaming website, the second user can click the displayed icon or link to be directed to the data privacy application and request generation of a physical mailer to be sent to another on-line gaming friend. For this purpose, the receiving user's screen name may be used as identification information that is used to initiate generation of the physical mailer and mail the physical mailer.

In one or more embodiments, a preauthorized permission or rule of a data structure identifies at least one user as being preauthorized or pre-approved to send one or more physical mailers to the first user. A preauthorized user may be identified by various criteria such as name, e-mail address, and phone number. A preauthorized permission or rule may also specify that a group of computing system users is allowed to send physical mailers to a receiving user. A group may be identified by, for example, a group e-mail address or an indication that any user having a certain domain is authorized to communicate with the receiving user and allowed to send the receiving user a physical mailer. Users or groups of users may also be blocked or prevented from sending a physical mailer to the first user based on the preauthorized permissions or rules of a data structure for a receiving user.

### BRIEF DESCRIPTION OF THE DRAWINGS

FIGS. 1A-D illustrate how computing systems may be structured according to embodiments to provide for generation of physical mailers while protecting personal data in on-line and physical world environments;

FIG. 2 is a flow diagram of one embodiment of a computer-implemented method for generation of a physical mailer while protecting personal data in on-line and physical world environments;

FIG. 3 depicts user experiences during interactions with computing systems according to embodiments including users signing up with and submitting a recipient search request to a data privacy application;

FIG. 4 is a flow diagram of further processing of a generated physical mailer according to certain embodiments;

FIG. 5 is a flow diagram depicting user sign up or registration with a data privacy application according to embodiments;

FIGS. 6A-D are wireframe diagrams generally depicting web pages or computer-generated user interfaces including a main or home page and pages allowing a user to sign up or register with computing systems according to embodiments;

FIGS. 7A-E illustrate examples of linked data structures generated according to embodiments for personal and other user data that may be used by searching users to identify another user in a database;

FIG. 8 is a flow diagram depicting how a user registered with a data privacy application can change settings including preauthorized permissions or rules and opting out of receiving mail from other users according to embodiments;

FIGS. 9A-C are wireframe diagrams generally depicting how an interactive user interface of a data privacy application may be structured according to embodiments to allow users to change preauthorized permissions or rules of account settings and edit their information such as email addresses, phone numbers, and online network unique user identifiers;

FIGS. 10A-B illustrate how data structures may be modified or updated by removing certain information according to embodiments such as removal of a user's phone number available to be searched by other users during a recipient search;

FIGS. 11A-B are a flow diagram illustrating how one user of data privacy application may search for another user of the data privacy application using certain identification information known by that user to locate the other user in a database and send the other user a physical mailer through the data privacy application according to embodiments;

FIGS. 12A-D are wireframe diagrams generally depicting how an interactive user interface of a data privacy application may be structured according to embodiments to allow users to initiate a recipient search to identify other registered users of the data privacy application computing system and initiate generation of a physical mailer;

FIG. 13 illustrates a data structure according to embodiments and configured for a preauthorized permission or rule that blocks another user from sending the user physical mailer through the data privacy application;

FIGS. 14A-B illustrate data structures according to embodiments and configured for a preauthorized permission or rule that characterizes a user or group of user as preauthorized senders that are allowed to send another user physical mailers through data privacy application;

FIG. 15 is a wireframe diagram generally depicting how an interactive user interface of a data privacy application may be structured according to embodiments to notify a user that a recipient that was searched was not located in a database of the computing system;

FIGS. 16A-C are a flow diagram of a computer-implemented method according to an embodiment involving preauthorized permissions or rules for receiving a physical mailer at different addresses depending on the subject of a recipient search;

FIG. 17 is a wireframe diagram generally depicting how an interactive user interface of a data privacy application may be structured according to embodiments to control addresses and limit, block and unblock senders from a single page;

FIGS. 18A-C are wireframe diagrams generally depicting how an interactive user interface of a data privacy application may be structured for specifying one or more mailing addresses for physical mailers;

FIGS. 19A-B are wireframe diagrams generally depicting how an interactive user interface of the data privacy application may be structured according to embodiments to specify a preauthorized list or group of sending users of the data privacy application;

FIGS. 20A-B are a flow diagram of a computer-implemented method according to an embodiment for allowing a user of the data privacy application to control which contacts can receive mail such as contacts in a user's address book;

FIGS. 21A-C are wireframe diagrams generally depicting how an interactive user interface of a data privacy application can be structured according to embodiments to provide for control over which contacts can receive mail such as contacts in a user's address book;

FIGS. 22A-B are a flow diagram of a computer-implemented method according to an embodiment for inviting contacts to join the data privacy application;

FIGS. 23A-B are wireframe diagrams generally depicting how an interactive user interface of the data privacy application may be structured according to embodiments for granting the data privacy application access to contacts and invite contacts to join the data privacy application;

FIGS. 24A-B are flow diagrams of computer-implemented methods according to embodiments for blocking and unblocking certain users of the data privacy application from sending a physical mailer to a receiving user;

FIGS. 25A-C are wireframe diagrams generally depicting how an interactive user interface may be structured according to embodiments to allow a user to block and unblock other users of the data privacy application;

FIGS. 26A-B are a flow diagram of a computer-implemented method according to an embodiment for allowing a user that is not logged into the data privacy application to send a physical mailer such as a pre-designed card to another user who may be registered with the data privacy application;

FIGS. 27A-B are wireframe diagrams generally depicting how an interactive user interface of the data privacy application may be structured according to embodiments to allow a user that is not logged into the data privacy application to initiate generation of a physical mailer such as a pre-designed card to another user who may be registered with the data privacy application;

FIGS. 28A-C are wireframe diagrams generally depicting how an interactive user interface of the data privacy application may be structured to allow a user that is not logged into the data privacy application to design a physical mailer such as a card;

FIGS. 29A-B are a flow diagram of a computer-implemented method according to an embodiment for designing a physical mailer such as a card;

FIGS. 30A-C are wireframe diagrams generally depicting how an interactive user interface of the data privacy application may be structured according to embodiments to allow a user that is not logged into the computing system to design a physical mailer such as a card;

FIG. 31 illustrates an embodiment of an output file generated by the data privacy application and that is provided to a printer to generate a physical mailer;

FIG. 32 is system flow diagram further illustrating processing of a physical mailer generated according to embodiments including structural modification of a physical mailer and generation of a package including the physical mailer;

FIG. 33 is a flow diagram of a computer-implemented method according to an embodiment for generating a physical mailer in the form of a greeting card through the data privacy application and processing of shipping of the physical mailer; and

FIG. 34 a system diagram of components of a computing apparatus that may be utilized by various computing devices and system components.

### DETAILED DESCRIPTION OF ILLUSTRATED EMBODIMENTS

Embodiments of the invention protect the privacy of a user's personal data in a networked computing system or online computing application while also maintaining the privacy of that same personal data in the physical world when users of the networked computing system communicate with each other in the physical world and outside of the networked computing system. For example, one user of the networked computing system may send another user of the networked computing system a physical mailer in the form of a card, a postcard, a letter, or other object such as a gift or package. For this purpose, one user, as a sending user, may initiate generation of the physical mailer to be sent to another user, as a receiving user, through the networked computing system, while the receiving user's personal information such as the receiving user's real name and/or residence address are not disclosed to or known by the sending user.

Embodiments are thus in contrast to conventional systems and processes in which the sending user knows, and indeed must know, the receiving user's name and address, which must be added to a letter or package for mailing, and deposits the letter or package with a mail carrier or sends an electronic mail message or e-card using the known recipient's email address. In these conventional processes, the recipient's name, mailing address and/or email address are known by the sender to allow the sender to mail a letter or package, but the point of embodiments is to protect against disclosure of personal data required by these conventional systems and processes.

More particularly, embodiments of the present invention utilize a special-purpose, intermediate computing system that is used to generate or initiate generation of a physical mailer while protecting the privacy of personal data of one or both of the receiving user and the sending user. For example, while the receiving user's name and address are printed on the physical mailer (and thus made “public” to some degree by being shipped or mailed), with embodiments, the sending user does not actually possess or even see the physical mailer with this information. Further, the sending user is not provided with the physical mailer before being sent to the receiving user. Thus, the receiving user's personal data of their name and/or mailing address remain private relative to the sending user, and the sending user, unlike in scenarios where the sending users uses the United States Postal Service or other delivery service, does not handle the physical mailer sent to the sending receiver.

Embodiments may be used to generate different types of physical mailers on behalf of a sending user for delivery to a receiving user. For example, embodiments may be used to generate physical documents, e.g., a card, such as a greeting card, a letter, a postcard and other documents. A physical mailer may or may not require an envelope or other packaging. Examples of physical mailers and associated manufacturing processes for same are described in the following published patents and published patent applications, the contents of which are incorporated herein by reference: U.S. Pat. No. 5,873,073 to Bresnan et al. entitled “Method And System For Mail Piece Production Utilizing A Data Center And Inter-related Communication Networks,” U.S. Pat. No. 5,918,220 to Sansone et al. entitled “Method And System For Worldwide Media Selection, Production, And Delivery,” U.S. Pat. No. 7,100,348 to Mertens entitled “Continuous Strip Of Detachably Interconnected Folded Products,” U.S. Pat. No. 7,369,918 to Cosgrove entitled “System And Apparatus For Generating Mailers On Demand,” U.S. Pat. No. 8,616,434 to Wilen entitled “Multi-component Forms,” U.S. Patent Application Publication No. US2011/0106596 to Cosgrove entitled “System And Method Of Generating Postal Mailers For Free,” U.S. Patent Application Publication No. US2014/0197229 to Rodgers entitled “Multi-ply Mailer With Multiple Detachable Elements,” and EP0400316 to Erber et al. entitled “Apparatus And Method For The Manufacture Of Mailers.”

Embodiments may also be used to request delivery of objects and goods such as gifts, flowers, etc. For ease of explanation and not limitation, certain embodiments are described with reference to a physical mailer, with a particular example of a greeting card. However, it will be understood that embodiments are not so limited.

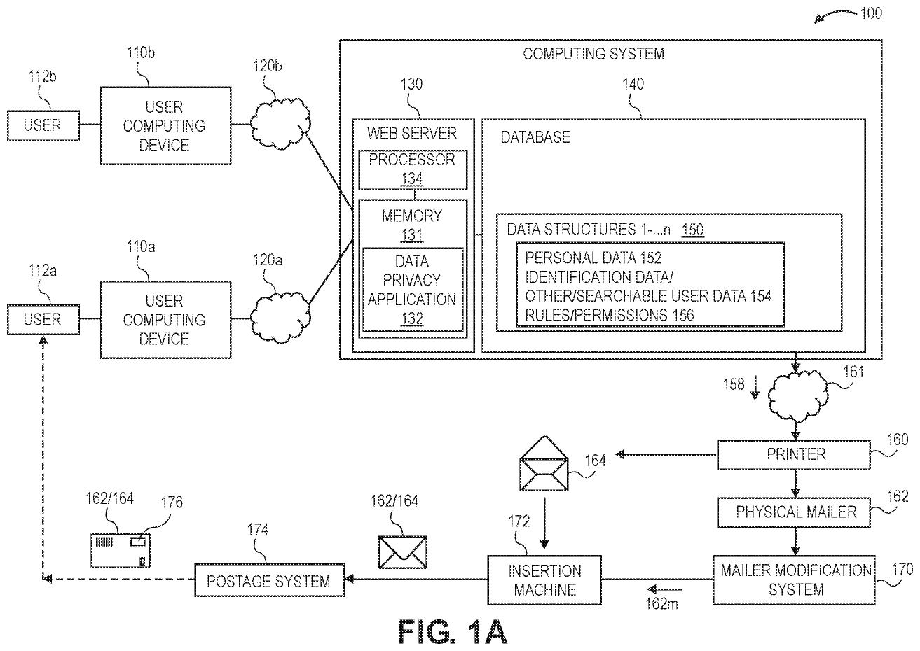

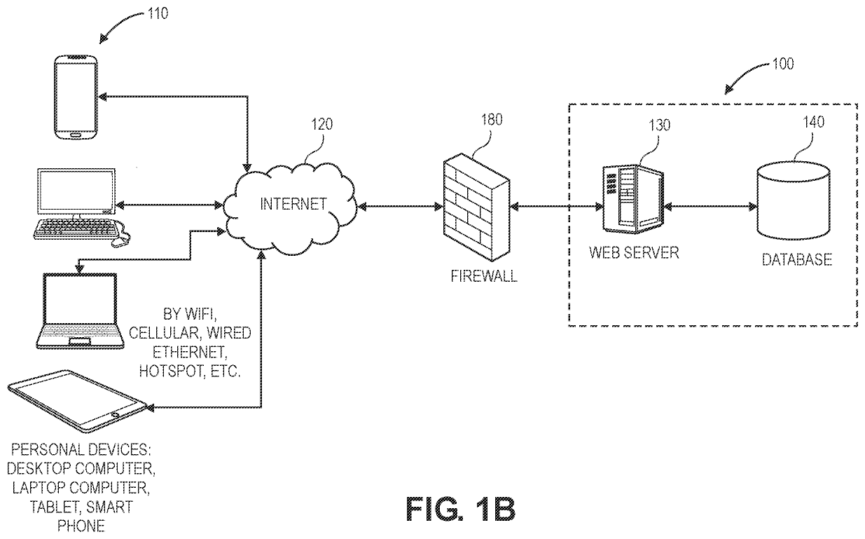

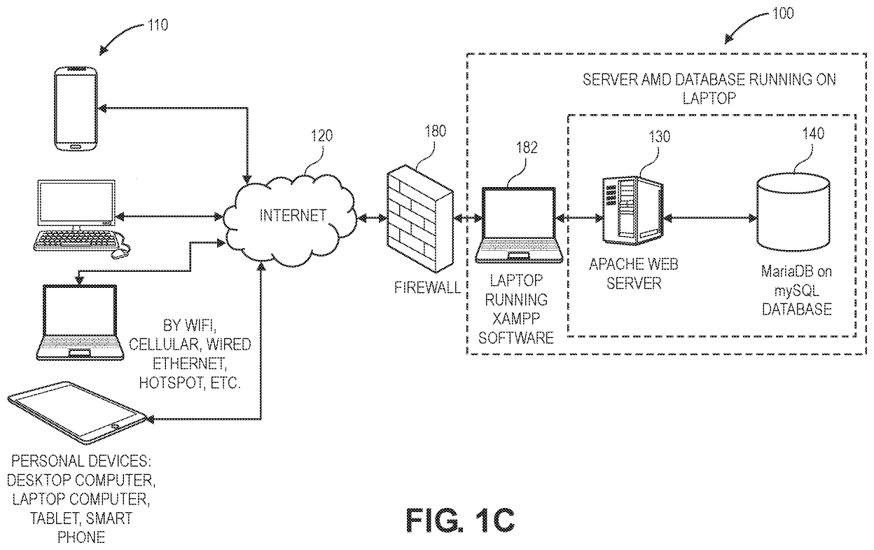

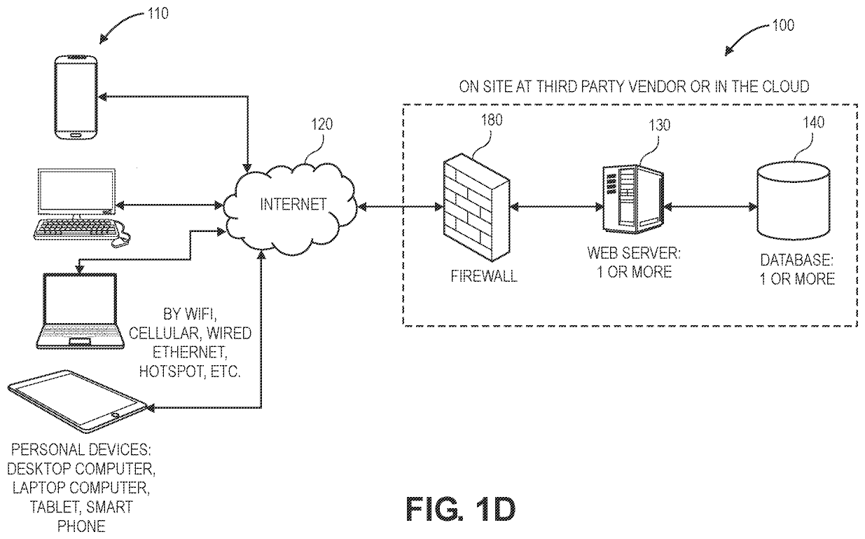

Referring to FIG. 1A, in one embodiment, a computing system 100 is in communication with respective user computing devices 110a-b (generally, user computing device 110) of respective users 112a-b (generally, user 112) through respective communication networks such as Internet connections 120a-b (generally, Internet connection 120). Various communication networks 120 may be utilized for communication with web server 130, but for purposes of explanation, not limitation, reference is made to Internet connection 120.

User computing device 110 may be a desktop computer, a laptop computer, a tablet, a smart phone, or similar device with access to Internet via a wired, wireless, cellular, or other network to establish Internet connection 120 with one or more web servers 130 (one web server illustrated for purposes of explanation). User computing devices 110 include a suitable operating system and Internet browser for accessing the computing system 100 via Internet connection 120. Examples of suitable operating systems for user computing devices 110 include Windows 10 by Microsoft Corp., Redmond, Wash.; iOS by Apple Inc., Cupertino, Calif.; Android OS by Open Handet Alliance, part of Google of Alphabet Inc., Mountain View, Calif.; Ubuntu open source OS which is supported by Canonical Ltd of London, United Kingdom; or similar. Examples of web browsers for user computing devices 110 include Chrome by Google of Alphabet Inc.; Edge by Microsoft Corp.; Safari by Apple Inc.; Firefox open source web browser by Mozilla Foundation of Mountain View, Calif., USA, and similar web browsers.

According to one embodiment, computing system 100 includes web server 130, a data privacy application 132 and one or more databases 140 (one database is illustrated for purpose of explanation and illustration). Web server 130 hosts data privacy application 132 that includes computer-executable instructions stored in a memory 131 of web server 130 and that are executed by a processor 134 of web server 130. Data privacy application 132 is accessible by user computing devices 110 through Internet connection(s) 120 and controls how protected personal data 152 stored in database 140 of computing system 100 is used in online computing and physical world environments outside of computing system 100.

Web server 130 is also in communication with database 140, which includes one or more data structures 150 for each user 112 that has signed up or registered with data privacy application 132. Data structure 150 may include or involve one or more different types of data including one or more or all of a user's personal data 152, identification data or other known user data 154, and permissions or rules 156. Examples of personal data 152 include a user's real or legal name and residence or mailing addresses. Examples identification data 154 include data that is available for searches by other registered users of data privacy application 132 and that is known by or previously disclosed to these other users. For example, one user may know identification data 154 of another user such as the other user's previously used or public e-mail address or a known or previously provided phone number. For ease of explanation, reference is made to identification data 154 of a user that is designated as being searchable by other users. Permissions or rules 156 specify how personal data 152 that is to be protected is utilized by or within computing system 100 and in the physical world outside of computing system 100. Permissions or rules 156 also specify how queries submitted through computing system 100 involving certain identification data 154 used to identify a user impact use of personal data 152 for generation of a physical mailer 162, which may or may not include one or more user's personal data 152.

In the following and other descriptions, reference to certain types of data for a particular user, such as a first or receiving user 112, is reference with “a” (e.g., first or receiving or recipient user 112a), and reference to data of another user such as a second or sending user, is identified with “b” (e.g., second or sending user 112b). While embodiments are described with reference two users, 112a and 112b, it will be understood that embodiments may involve thousands or millions of users 112. Thus, reference is made to a user 112 generally and user computing device 110 generally, and different figures may depict different numbers of users and components.

FIG. 1A depicts different users 112a and 112b and user computing devices 110a and 110b and data structures 150 with different types of data generally for various users 112. In one embodiment, permissions or rules 156 specify how personal data 152 of a first or receiving user 112a may be utilized by a second or sending user 112b who wants to send first user 112a a physical mailer 162 in the physical world based on a request submitted through computing system 100. For example, permission or rule 156 may specify that a user has opted to receive mail from all other users of data privacy application 132, only from some or selected users of data privacy application 132 (by name or by group, or by blocking certain users or a group of users), or that a user will not receive mail from any user or group of users of data privacy application 132. As another example, permission or rule 156 may involve account settings that can be selected by a user to specify how certain personal data 152 of a user can be utilized outside of computing system 100.

For example, first user 112a may specify that first user's work mailing address (rather than residence address) is to be used to receive physical mailer 162 generated on behalf second user 112b when second user 112b identified first user 112a as a registered user of data privacy application 132 using a work-related query including identification data 154 of a professional networking website (such as the LINKEDIN professional networking website), a work email address, or a work phone number. As another example, permission or rule 156 may involve first user's 112a account settings that specify that the home or residence mailing address (rather than work address) of first user 112a is to be used to receive physical mailer 162 generated on behalf of second user 112b when second user 112b identified first user 112a as a registered user of data privacy application 132 using a query involving identification data 154 of a certain personal email address (such as the user's private or personal email address rather than a work-related email address). Permission or rule 156 may also specify that home and work mailing addresses are used for certain dates and/or times, or are temporary. A user may specify a start and end dates/times. It will be understood that permission or rule 156 may specify that first user 112a will accept, or not accept, mail from second user 112b or other user that identified first user 112a using certain search criteria. Accordingly, it will be understood that data structures 150 may embody or utilize various permissions or rules 156 that involve personal data 152 that is to be protected and/or other identification data 154 of a user, and that such permission or rule 156 requirements are processed and enforced by data privacy application 132 for generation of physical mailer 162 while maintaining privacy of a user's personal data 152.

FIG. 1A further illustrates a printer 160 in communication with or a component of computing system 100. Printer 160 is operable to generate physical mailer 162 or transform data of physical mailer 156, or mailer data 158 and personal data 152 released by data privacy application 132 and incorporated into physical mailer 162. Thus, prior to being printed, physical mailer 162 did not exist. Printer 160 may be a local component of computing system 100 or a remote printer in communication with the computing system 100 via a network 161. FIG. 1A also illustrates a mailer modification system 170 that receives physical mailer 162 generated by printer 160 and structurally modifies physical mailer 162 as needed by cutting, folding, and/or scoring physical mailer 162. Physical mailer 162, or physical mailer 162 as structurally modified 162m (“m” referring to “modified”) is placed into an envelope or package 164 (generally, envelope 164) by insertion machine 172. FIG. 1A further illustrates a postage system 174 that receives envelope 164 with physical mailer 162 and prints or applies postage or a stamp 176 onto envelope 162 in preparation for shipping and delivery of physical mailer 162.

FIGS. 1B-D illustrate examples of how computing system 100 may be structured for use in different networked computing system configurations. Referring to FIGS. 1A and 1B, computing system 100 includes one or more web servers 130 executing data privacy application 132 accessible by one or more user computing devices 110a-d (generally, user computing device 110) and one or more databases 140 managed by data privacy application 132. Web server 130 and database 140 are illustrated as being located behind a firewall 180 and accessible by respective computing devices 110 via Internet connection 120.

Firewall 180 hardware and service may be provided by, for example, Next-Generation Firewall by Fortinet Inc. of Sunnyvale, Calif., USA; Firepower 1150 by Cisco Systems Inc. of San Jose, Calif.; SRX5400 by Juniper Networks Inc. of Sunnyvale, Calif., USA; Next Generation Firewall by Check Point Software Technologies Ltd. of Tel Aviv, Israel and Next Generation Firewall by Forcepoint LLC a subsidiary of Raytheon Technologies Corp. of Waltham, Mass., USA.

Web server 130 may use any commonly used web server software such as Apache by the Apache Software Foundation of Forest Hill, Md., USA; Microsoft Internet Information Services (IIS), a part of Microsoft Corp.; Nginx by Nginx Inc. of San Francisco, Calif., USA; or similar. Code for data privacy application 132 is hosted on web server 130 and may use HTML Hypertext Mark-up Language and/or PHP scripting language. Data privacy application 132 code may also include JavaScript and other related web languages.

Database 140 is in communication with web server 130 and may be local or reached via a network and execute MySQL, an open source software acquired by Oracle Corp. of Redwood City, Calif.; MariaDB open source software managed by MariaDB Foundation of Helsinki, Finland; SQL Server owned by Microsoft Corp., PostgreSQL open source software assisted by Software In the Public Interest Inc. of New York, N.Y., USA; MongoDB of MongoDB Inc. of New York, N.Y., USA; or any other commonly used database software. Database 140 may be a relational database, a NoSQL (non-tabular) database, a graph database (i.e., Neo4j), or other type of storage medium.

FIG. 1C depicts another example of a networked computing system 100 for purposes of development and includes a laptop computing device 182 executing XAMPP software. In this system configuration, laptop computing device 182 is configured as an Apache HTTP web server 130 and MariaDB database 140. In this configuration, laptop computing device 182 includes web server 130 and database 140. Laptop computing device 182 is used by the host or developer to interface with web server 130 and database 140, which are configured on the same laptop computing device 182, through an Internet connection. One example of a suitable laptop computing device 182 used for this purpose is an ASUS ZenBook laptop computing device made by ASUSTek Computer Inc. of Taipei, Taiwan, running operating system Windows 10 sold by Microsoft Corp. of Redmond, Wash., USA. Web server 130 may be structured as XAMPP, version 7.1.8, which is a web server and database hardware development tool by Apache Friends which is part of BitRock Inc. of San Francisco, Calif., USA. XAMPP features an Apache Web Server (version 2.4.27) and a MariaDB database (version 10.1.26) on top of mySQL, and are offered together by Apache Friends, for programming the website customer interface in PHP scripting language (version 7.1.8) and HTML markup language. Laptop computing device 182 may use Windows Defender Firewall or other commercially available firewall software products.

With continuing reference to FIG. 1A and with reference to FIG. 1D, in another embodiment of a networked computing system 100, web server(s) 130 and database(s) 140 are hosted on-site or by an external third party or in a cloud computing environment, or in the cloud. Web server 130 may be hosted on-site featuring type of web servers 130 noted above. Database 140 may be hosted on-site featuring database 140 hardware noted above. Hardware products and vendors for the various off-site web server 130 solutions include Lambda by Amazon Web Services of Seattle, Wash., USA; Google Cloud web hosting by Google Cloud Platform by Alphabet Inc.; Business Hosting by GoDaddy Inc. of Scottsdale, Ariz., USA; or similar. Database 140 may be hosted off-site by an external vendor such as Aurora by Amazon Web Services; Cloud SQL by Google Cloud by Alphabet Inc.; HANA by SAP SE of Walldorf, Germany; or similar database.

With continuing reference to FIG. 1D, web server 130 and/or database 140 may be hosted on a virtual machine or set of machines in a cloud computing environment. Each virtual machine includes an application and operating system and may occupy a portion of the memory and hard disk of a computer, web server 130, or database 140. Virtual machine hardware may host multiple virtual machines. Virtual machine products and vendors for web server hardware services include: Azure by Microsoft Corp., EC2 by Amazon Web Services, IBM Cloud Virtual Servers for Classic by IBM Corp. of Armonk, N.Y., or similar virtual machine products. Virtual machine products and vendors for database hardware services include: Oracle Database on Virtual Machines by Oracle Corp., Azure Virtual Machines by Microsoft Corp., IBM Cloud Databases for PostgreSQL by IBM Corp., or similar virtual machine.

With continuing reference to FIG. 1D, in another embodiment, web server 130 and/or database 140 are in a container or containers on a virtual machine or machines in the cloud computing environment. Containers hold applications on a piece of hardware that shares an operating system. The applications are kept separate from each other by the container. Since containers do not hold an operating system, containers are smaller than virtual machines. Container run-time environment products and vendors may include Docker open source tools from Docker Inc. of San Francisco, Calif., USA; CRI-O Container Runtime Interface open source supported by Red Hat owned by IBM Corp.; rkt Rocket supported by CoreOS owned by IBM Corp.; or similar. In order to enable the management of virtual machines, a hypervisor hardware, firmware, or software may be included. Hypervisor products and vendors include: vSphere Hypervisor by VMware Inc. of Palo Alto, Calif., USA; or similar. Products and vendors for a web server in a container or containers on a virtual machine or machines include: ECS by Amazon Web Services, GKE by Google of Alphabet Inc., and Azure Container Instances by Microsoft Corp. Vendors for a database in a container or containers on a virtual machine or machines include: Oracle Database using CDB by Oracle Corp., IBM Cloud Kubernetes Service by IBM Corp., HPE Ezmeral Container Platform by Hewlett Packard Enterprise of San Jose, Calif., or similar systems.

Further, web server 130 and/or database 140 can reside on a bare metal server on-site or off-site at an external vendor. Bare metal servers are hardware that are dedicated to a single user, this is unlike virtual machines and containers. Bare Metal server products and vendors for web servers include: ECS Bare Metal Instance by Alibaba Group Holding Limited of Hangzhou, China; EC2 i3.metal by Amazon Web Services; Bare Metal Server by IBM Corp; and similar. Bare Metal vendors for database include OnMetal I/O v2 by Rackspace Inc. of Windcrest, Tex., USA; Bare Metal X7 Database Enterprise Edition by Oracle Corp.; and similar.

In another embodiment, still referencing FIG. 1D, web server 130 and/or database 140 may reside in a serverless architecture in which hardware for web server 130 and database 140 are off-site and managed by an external vendor using multiple machines or portions of machines while leaving the allocation of all hardware resources up to the external vendor. The vendor decides how to allocate hardware resources and change them as necessary. The user hardware is as mentioned above: desktop computer, laptop computer, tablet, smart phone, or similar with access to the internet. Products and vendors for serverless architecture products for web servers 130 and databases 140 include: Lambda by Amazon Web Services, App Engine by Google of Alphabet Inc., Azure serverless products by Microsoft Corp, Cloundant by IBM Corp. and similar systems.

Thus, it will be understood that various networked computing system 100 configurations may be utilized to implement embodiments, and for ease of explanation and illustration, reference is made generally to computing system 100 and in particular, computing system 100 as depicted in FIG. 1A.

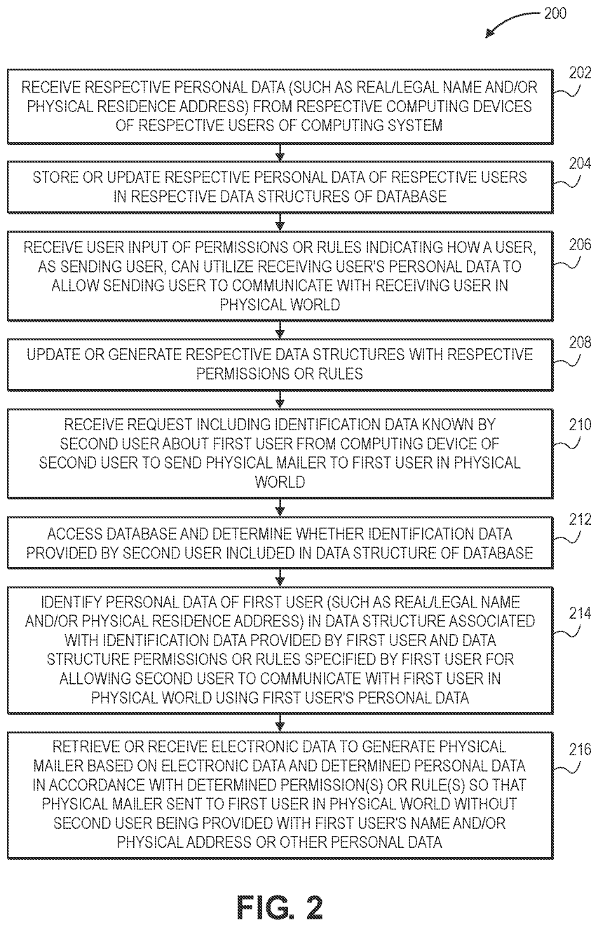

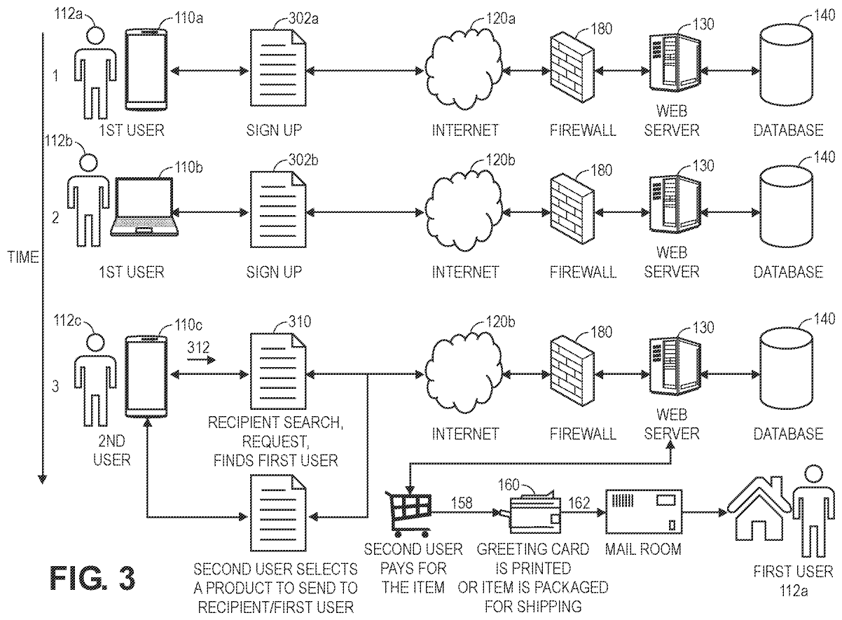

Referring to FIGS. 2-3, and with continuing reference to FIG. 1A, in an embodiment of a computer-implemented method 200 for generating or initiating generation of generating physical mailer 162 through computing system 100 while protecting the privacy of personal data 152 of one or multiple users in computing system 100 and physical world environments. At 202, data privacy application 132 executing on web server 130 receives respective personal data 152 (such as real or legal name and/or physical residence address of a user) from computing devices 110a, 110b of users 112a, 112b of data privacy application 132. Personal data 152 may be received when users 112a, 112b register or sign up 302a, 302b with data privacy application 132 or when a registered user 112 updates personal data 152 of data structure 150 of database 140.

FIG. 3 generally depicts the user experience of two users—a first user 112a and a second user 112b. First user 112a, through user computing device 110a, accesses data privacy application 132 through Internet connection 120a and signs up or registers 302a with data privacy application 132. For this purpose, first user 112a submits their personal data 152a such as the first user's name and home residence address and known user data or other identification data 154a related to first user 112a. Similarly, second user 112b, through user computing device 110b accessing data privacy application 132 through Internet connection 120b, signs up or registers 302b with data privacy application 132, which also involves submitting personal data 152b such as the second user's name and home residence address and known user data or other identification data 154b.

Referring again to FIG. 2, at 204, data privacy application 132 stores personal data 152 of users 112 to their data structures 150 of database 140 or updates data structures 150 if a user 112 has already registered with data privacy application 132.

At 206, data privacy application 132 receives input from a first user 112a, as a receiving user, regarding how the first user's personal data can be used by another user of data privacy application 132 as a sending user to communicate with first user 112a in physical world and separately of computing system 100. At 208, data privacy application 132 generates or updates first user's 112a data structures 150 in database 140 with associated permissions or rules 156 reflecting user input. Thus, these permissions or rules 156 are preauthorized in that they are prior to a request by another user to communicate with first user 112a or, on other words, specified before such communication requests by other users.

At 210, data privacy application 132 of web server 130 receives a request to generate physical mailer 162 to send to another user and includes a request for “recipient search request” 310 or locate first user 112a. Recipient search 310 includes known user data or identification information 312 known by second user 112b about first user 112a to send physical mailer 162 to first user 112a in physical world. Recipient search 310 is received from computing device 110b of second user 112b.

FIG. 3 further depicts how a user, after signing up or registering 302 with data privacy application 132, becomes a “sending” user to submit a request for generation of physical mailer 162 to send to another user as a “receiving” user. Thus, in this particular example, first user 112a is the receiving or recipient user, but first user 112a may also request to send a physical mailer 162 to another user. Similarly, in this particular example, second user 112b is the sending user, but second user 112b may receive physical mailers 162 from other users too. Thus, a particular user may transition between being a “sending” user and a “receiving” user and vice versa.

Referring again to FIG. 2 and with continuing reference to FIG. 3, at 212, data privacy application 132, in response to recipient search 310, determines whether identification information 312 provided by second user 112b as part of recipient search 310 is included in a data structure 150 of database 140. If not, this indicates that first user 112a is not registered with data privacy application 132. Alternatively, first user 112a may be registered as shown in example depicted in FIG. 3, but first user 112a has not updated database 140 with that identification information 312 if it is indeed applicable to first user 112a, in which case second user 112b can be notified by computing system 100 that no match was found.

Otherwise, at 214, data privacy application 132 locates identification information 312 of recipient search 310 as known user data or identification data 154 previously stored in data structure 150 and in turn identifies associated personal data 152 of first user 112a. This personal data 152 may be first user's real/legal name and/or physical residence address. Data privacy application 132 also identifies preauthorized permissions or rules 156 specified by first user 112a for allowing second user 112b to communicate with first user 112a in physical world using first user's personal data 152. At 216, data privacy application 132 retrieves or receives mailer data 158, which may be based on a user design selected by sending user 112b (as depicted in FIG. 3) or according to a pre-determined template. Sending user 112b pays for physical mailer 162 (indicated by the shopping cart in FIG. 3), and mailer data 158 and identified personal data 152 are received by printer 160 from data privacy application 132 or computing system 100. Physical mailer 162 including mailer data 158 and personal data 152 is printed in accordance with identified preauthorized perm ission(s) or rule(s) 156. Printed physical mailer 162 is sent to first user 112a in physical world without second user 112b being provided with first user's personal data 152 such as first user's name and/or mailing address. Further, depending on permission or rule 156 of second user 112b, first or receiving user 112a may be able to send physical mailer 162 back to second or sending user 112b.

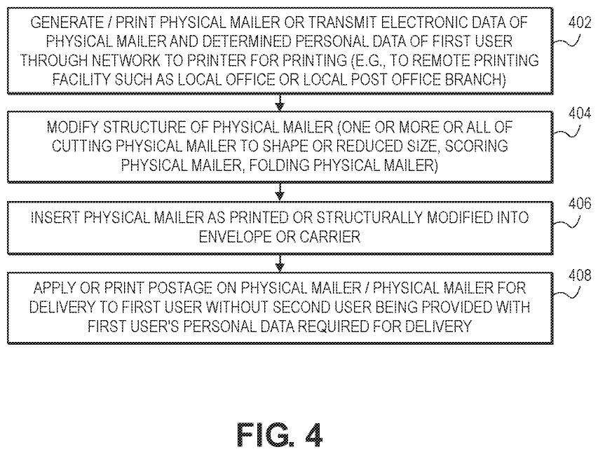

Referring to FIG. 4, and with continuing reference to FIGS. 1A and 2, embodiments may also involve additional system components and associated processing for generating or printing physical mailer 162, or generating or printing a physical mailer 162 and structurally modifying printed physical mailer 162.

According to certain embodiments, computing system 100 includes printer 160 for generating physical mailer 162. Printer 160 is in communication with web server 130 and may be a local or on-site printer or a printer that is located remotely relative to computing system 100 and in communication with computing system 100 via network 161. Thus, at 402, data privacy application 132 of computing system 100 generates or prints physical mailer 162, or transmits mailer data 158 and determined personal data 152 of first user 112a through network 161 to remote printer 160 for printing of physical mailer 162.

For example, data privacy application 132 may identify an office of computing system host or post office branch in first user's 112a city. Rather than print physical mailer 162 and mail physical mailer 162 from the location of on-site printer 160, an electronic data file including mailer data 158 and identified personal data 152 can be transmitted through network 161 to a remote printer 160 that is closer to first user 112a or closer to the identified post office branch. In this manner, generation of physical mailer 162 and subsequent physical mailer 162 processing such as cutting, folding, and modification operations (FIG. 4, 404) can be performed closer to receiving or first user 112a for more efficient delivery of physical mailer 162 by reducing shipping distances and delivery times.

Referring again to FIG. 1A and with continuing reference to FIG. 4, according to certain embodiments, computing system 100 includes mailer modification system 170 for changing a structure of physical mailer 162 generated by printer 160 to form modified physical mailer 162m at 404. Mailer modification system 170 may cut, shape, score, or fold printed mailer 162 into a different structural form for insertion into an envelope or package 164 at 406 by insertion or packaging machine 172 (generally, insertion machine 172).

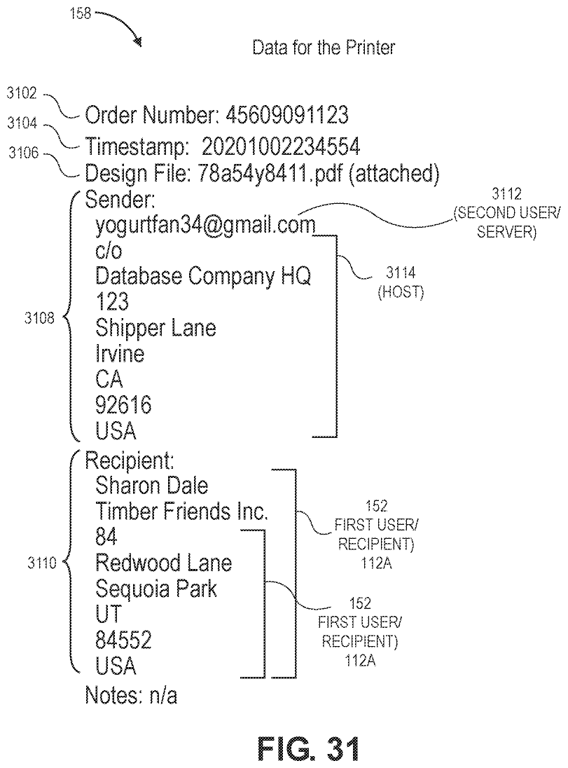

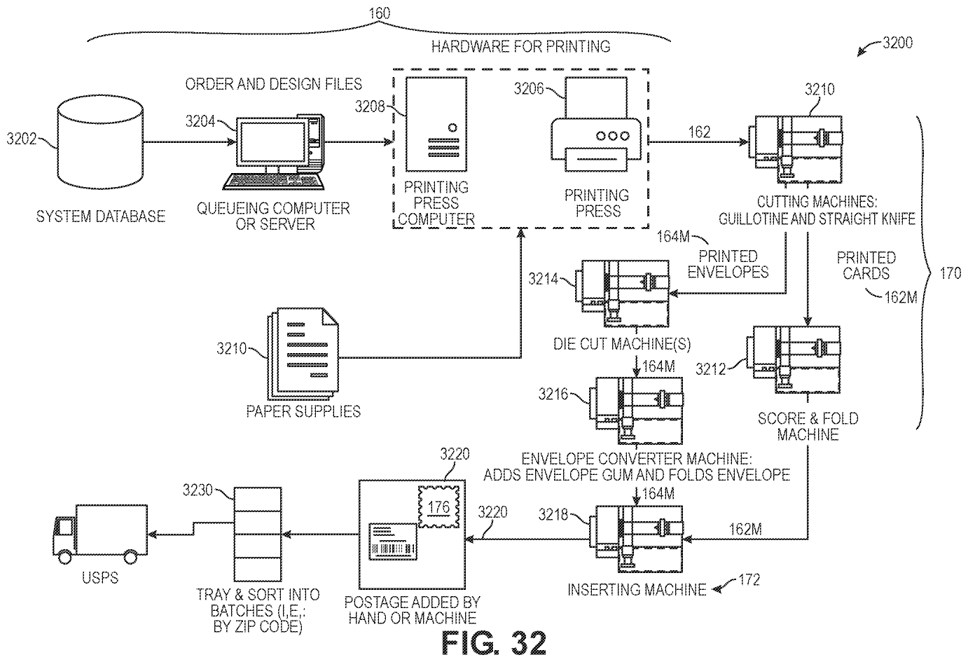

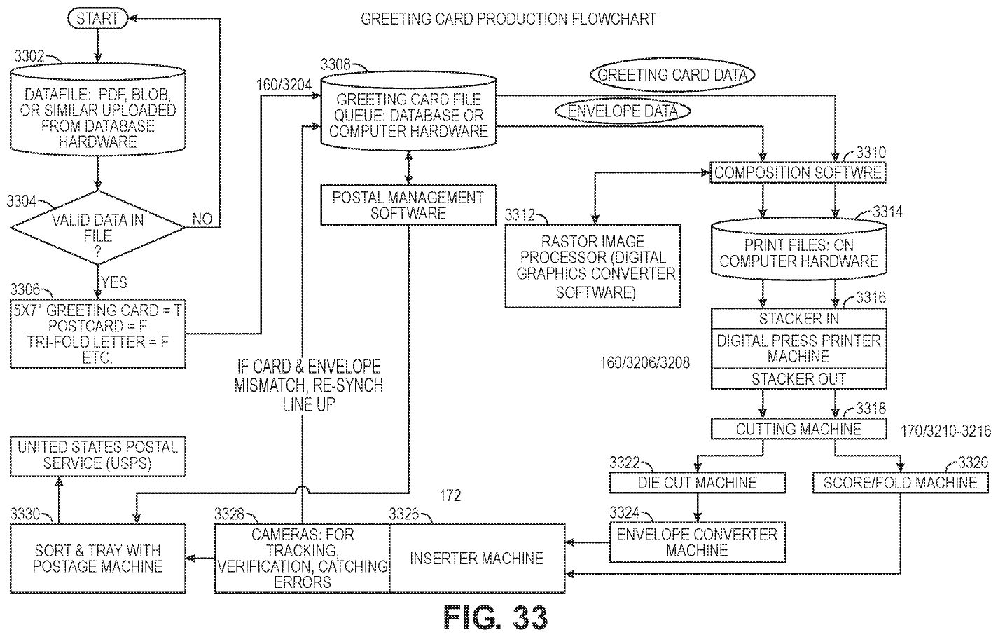

As described in further detail with reference to FIGS. 32-33, mailer modification system 170 may include one or more or all of a cutting machine, a scoring machine, and a folding machine, which are used to reconfigure physical mailer 162 by reshaping and/or resizing physical mailer 162 generated by printer 160. According to certain embodiments, computing system 100 may include insertion machine 172 that is operable to place printed physical mailer 162 or modified physical mailer 162m into envelope 164.

Mailer modification system 170 and insertion machine 172 may be a local or on-site or located remotely relative to computing system 100. Further, if physical mailer 162 modification is not required, physical mailer 162 as generated by printer 160 can be provided to insertion machine 172.

According to certain embodiments, at 408, output of insertion machine 172, in the form of a combination of physical mailer 162 and envelope 164, may be provided to a postage system 174. Postage system 174 applies or prints postage 176 onto physical mailer 162 or envelope or package 164 thereof. After application of postage 176, physical mailer 162/envelope 164 are ready for shipping and delivery to first or receiving user 112a, without second or sending user 112b being provided with first user's 112a personal data 152 that is needed to mail and deliver physical mailer 162 to first user 112a.

Embodiments are adaptable to different situations in which users of data privacy application 132 know each other personally and know each other's personal data 152, and in situations in which they do not. For example, embodiments can be used when second or sending user 112b desires to send first or receiving user 112a a physical mailer 162, and for this purpose, second user 112b may already know certain identification information 312 about first user 112a. For example, second user 112b may know first user's 112a e-mail address or cell phone number. However, second user 112b may not know first user's 112a residence or other mailing address that is needed to actually send physical mailer 162 to first user 112a. Embodiments are also applicable to situations in which users do not know each other personally such as when users are virtual or online friends. In these virtual or online situations, users may know each other through a social networking website or online game, but these virtual friends may not know each other's real names and/or residence or other mailing address in the physical world.

For example, first and second users 112a and 112b may be co-workers, and second user 112b, as a sending user, wishes to send first user 112a a wedding invitation or other physical mailer 162. Second user 112b may know some information 312 about first user 112a, such as the first user's work e-mail address since first and second users 112a, 112b work together, but second user 112b may not know personal data 152 about first user 112a such as first user's 112a residence address, which is needed to actually mail and deliver the wedding invitation to first user 112a. In this illustrative example, second user 112b may submit a recipient search 310 to data privacy application 132 of computing system 100 to generate physical mailer 162 in the form of a wedding invitation, and for this purpose, second user 112b provides known identification information 312 about first user 112a, such as first user's 112a work e-mail address in this example. Data privacy application 132 of computing system 100 receives recipient search 310 with this second user 112b supplied identification information 312 and searches database for matching information. Data privacy application 132 also identifies first user's 112a personal data 152 and associated preauthorized permissions or rules 156 specifying restrictions on how this personal data 152 may be utilized and who may communicate with first user 112a or send first user 112a physical mailer 162. Assuming those rules or restrictions 156 are satisfied, data privacy application 132 generates or coordinates generation of physical mailer 162 in the form of a wedding invitation that includes personal data 152 of first user 112a (e.g., home address), while second user 112b does not know, does not have access to and is not provided with first user's personal data 152 of a home address. Wedding invitation physical mailer 162 is generated and mailed without second user 112b even seeing the wedding invitation and without second user 112b seeing the first user's home address on the wedding invitation. Thus, first user's personal data 152 is maintained as secret or private relative to second user 112b, and physical mailer 162 is generated, mailed, and delivered to first user 112a without second user 112b knowing where the first user 112a actually lives. In this manner embodiments not only protect first user's personal data 152 in an online computing environment, but also protect this same personal data 152 in a real world or physical world environment.

As another illustrative example, first user 112a and second user 112b of data privacy application 132 both play an on-line game or use the same social networking website for which they have respective user names. For example, the user name of first user 112a or gamer may be “minecraftexpert” and the user name of second user 112b or gamer may be “falloutboy.” However, these “virtual friends” may not know each other's real names or mailing addresses. Instead, they only “know” each other in a virtual on-line environment by their fictitious user names. In this example, second or sending user 112b “minecraftexpert” may submit a recipient search 310 to data privacy application 132 to generate physical mailer 162 to be sent to first user 112a “falloutboy.” For this purpose, second user 112b provides identification information 312 that second user 112b knows about first user 112a, namely, first user's on-line gaming user name, “falloutboy” or this user name and the name of the related social network or game. In response to recipient search 310, data privacy application 132 searches database 140 for data matching identification data 312 provided by second user 112b. If a match between identification data 312 provided by second user 112b and data in database 140 is identified, then data privacy application 132 proceeds to identify personal data 152 of first user 112a. Personal data 152 may include the real name and home address of “falloutboy” and associated preauthorized permissions or rules 156 that first user 112a has established specifying physical world communication restrictions. Assuming those rules or restrictions 156 are satisfied, data privacy application 132 generates or coordinates generation of physical mailer 162 based on mailer data 158 and personal data 152 of first user 112a such as first user's real name (e.g., John Smith) and home address (e.g., 123 Main Street, Anytown, USA). Second user 112b known by the username, e.g., “minecraftexpert,” however, does not have access to and is not provided with first user's 112a real name or home address, but second user 112b is still able to request generation of physical mailer 162 to be sent to first user “falloutboy's” home.

As yet another example, embodiments allow users 112 to send mail to friends, family, and professional contacts when users 112 do not have personal data 152 such as a mailing address for their friends, family, and personal contacts. Often, a user 112 knows certain identification information 312 such as a friend's phone number or email address or unique social network ID. By offering computing system 100 for people to sign up and consent to receiving mail, friends, and contacts may send each other mail even when personal data 152 such as a residential mailing address is not known. This is especially useful when sending mail to an internet or virtual friend as the above examples illustrate. For example, members of an online gaming community can request generation of hardcopy congratulations cards that are to be mailed to others in the gaming community. A social network friend can send a hardcopy condolence card. A celebrity could send a special hello note to the members of their fan club. A professional contact could send a hardcopy thank you card for receiving help with a new business lead. Embodiments of the present invention may also be used to allow consenting users 112 to receive greeting cards. In the future, this proprietary computing system 100 could allow users 112 to send t-shirts, book, prizes, flowers, gifts, and more to their online friends. An additional advantage is that users 112 would not have to keep track of their contacts who move frequently since they can be located through computing system 100 and users 112 can send a card to whatever address is currently on file with the system database 140.

Thus, in contrast to conventional systems and mail processes that require a sender to know and add a recipient's mailing address to an envelope or packaging, and then deposit the completed letter or package with a mail carrier, embodiments of the present invention provide very different systems and methods for generating physical mailers 162 while simultaneously protecting sensitive or personal user data 152 of first or receiving user 112, which is not disclosed to second or sending user 112b. With embodiments, for example, second or sending user 112b is not provided with, and does not have access, to first or receiving user's 112a mailing address. With embodiments, physical mailer 162 can be sent to someone without knowing where that person lives, or even knowing that person's name or both—not knowing their real name and not knowing where they live. These unique capabilities and attributes of embodiments are very different compared to conventional mailing systems. Further, with embodiments, a first user 112a that is open to receiving physical mailer 162 need not share her or his mailing address or other personal data 152 with second user 112b in order to receive mail, thus, providing first user 112a with a level of privacy that does not exist in conventional mailing systems and processes. As will be understood, embodiments are not only very different compared to conventional mailing systems and processes, but various aspects of embodiments are the opposite of conventional mailing systems and processes. These very unique features and capabilities of embodiments are achieved in an internet-based service that operates to generate physical mailer 162 and coordinate or subsequently process and ship physical mailer 162 without second user 112b preparing, possessing physical mailer 162 or even seeing physical mailer 162, and without requiring second user 112b to deposit physical mailer 162 in the mail. These unique features and capabilities of embodiments are achieved while also maintaining privacy of second user 112b data 152 in both on-line and physical world environments. Accordingly, embodiments are very different compared to conventional mailing systems and processes, which not only require a sender to know the name and address of the recipient (which embodiments are designed to specifically prevent), but also require a sender to prepare and drop off a letter or package with the recipient's information at a post office or drop box.

Embodiments also provide for controllable and adjustable permissions or rules 156 to provide for user-specified or customized privacy in on-line and physical world environments. These preauthorized permissions or rules 156 allow first or receiving user 112a to control the receipt and non-receipt of physical mailers 162 not offered by conventional mail processes. In addition, first user 112a is able to receive physical mailer 162 using his or her own identification data 154, which may be identification information 312 that first user 112a has already shared with others in her or his electronic communications with others. Therefore, in contrast to conventional mailing processes, embodiments allow for first user 112a to receive physical mailers 162 based on first user's identification data 154 that was previously shared with or known by second user 112b. Thus, identification information 312 already known by and provided by second user 112b need not be maintained as private. No mailable products or related systems and processes are known in the art that offer a second or sending user 112b the ability to send, through a computer-based system, a mailable product to a receiving or first user 112a without second user 112b knowing first user's 112a mailing address while simultaneously protecting first user's 112a private and personal data 152 in both online and physical world environments. Accordingly, embodiments of the present invention offers multiple technological, security, and efficiency improvements and advantages over existing database and mailing systems and processes.

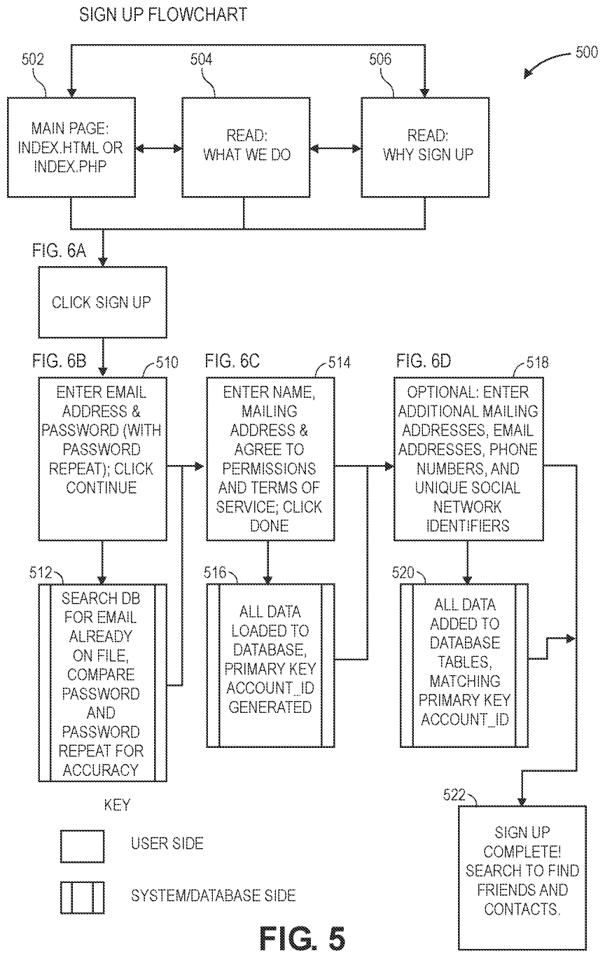

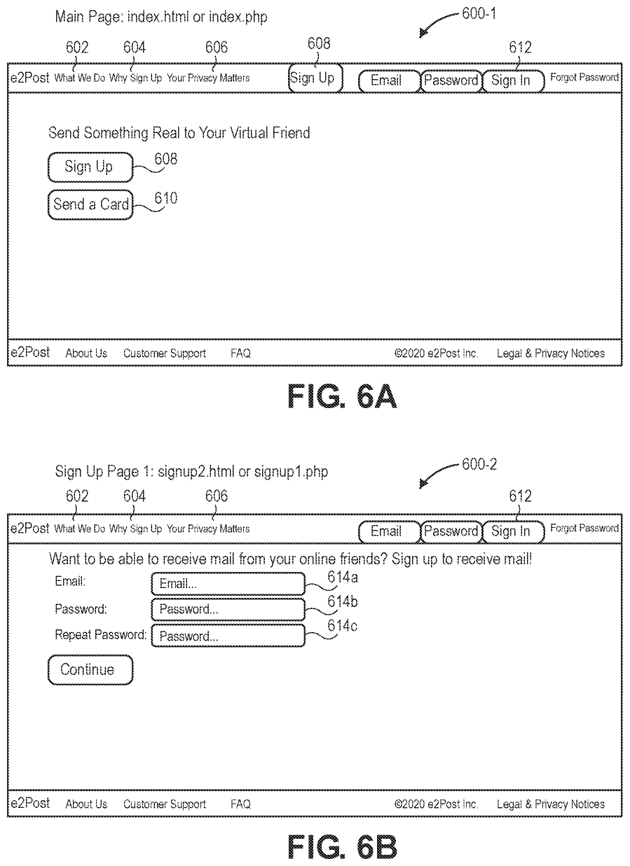

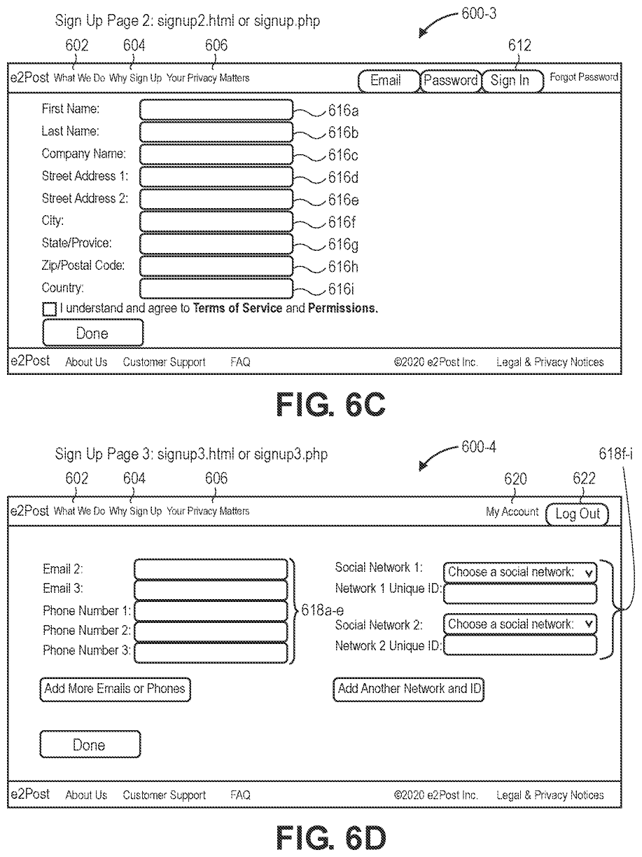

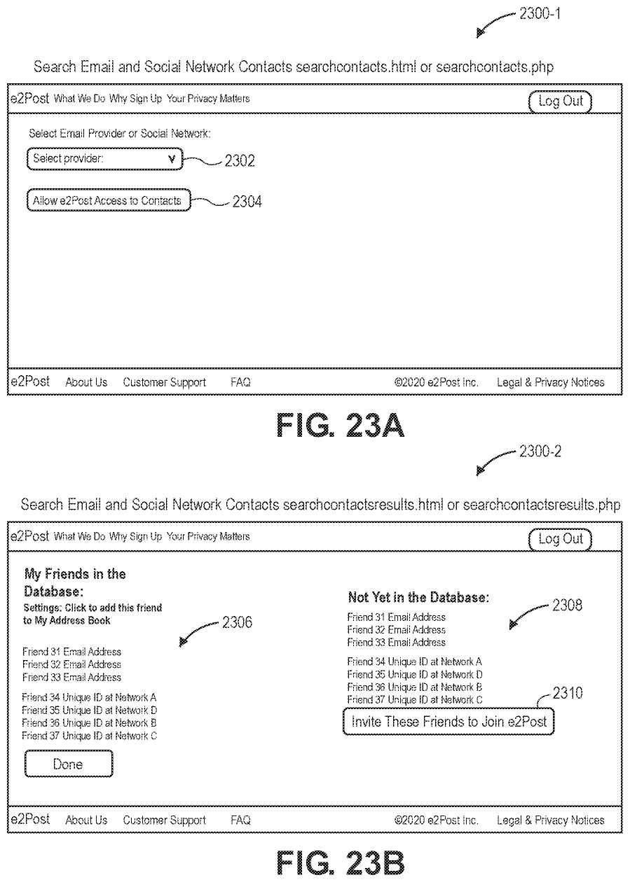

Specific examples of how embodiments may be structured and implemented are described with reference to FIGS. 5-34, which include wireframe diagrams depicting how web pages and user interfaces thereof may be configured, flow diagrams, and data structure 150 configurations for use in embodiments, Aspects of interactive user experiences and interactions with data privacy application 132 of computing system 100 are described including how users sign up or register with data privacy application 132, how users 112 control and change data structures 150 and find other users 112 who are registered with data privacy application 132, set up an address book, send mail, and receive mail. Wireframe diagrams depict how interactive user interfaces generated by data privacy application 132 may function and be structured, although it will be understood that various user interface configurations and interactive functionalities may be utilized. Flow charts depict user interaction steps (regular blocks) and processing by computing system 100, such as by data privacy application 132 (blocks with double lines), which is not visible to users 112. Pages of interactive user interfaces referenced in flow diagrams (e.g., FIG. 5) and depicted in wireframe diagrams (e.g., FIGS. 6A-D) are identified by common reference numbers, and multiple pages for a particular topic or related user experience are identified by “−1,” “−2” and so on.

User computing device 110 communicates via Internet connection 120 with data privacy application 132, and user interacts with user interface generated by data privacy application 132. A user's session data generated based on a user's navigation of pages of the interactive user interface is tracked from page to page and saved to database 140 through commands generated when user clicks buttons on the interactive user interface generated by data privacy application 132. Data privacy application 132 also uses cookies, stored on user computing device 110, to track the user's non-personally identifiable activities, including, for example, previous card design preferences, previous pages viewed, and tracking shopping carts prior to purchase. Pages of data privacy application's interactive user interface, including index (home) page 600

Referring to FIGS. 5 and 6A-D, in a method 500 according to one embodiment, at 502, a user 112 begins at a home or main page 600-1 of interactive user interface generated by data privacy application 132. At 504 and 506 of FIG. 5, user 112 can click a UI element such as buttons, tabs or menu links 602, 604 and 606 in header portion of main page 600-1 to learn about “What we do” or the capabilities of data privacy application 132 and why users should sign up or register with data privacy application 132 for to protect privacy of their data. For example, main page 600-1 may provide information to users about how data privacy application 132 may be used to send mail to online friends, receive mail, and also provides a “Sign Up” UI element or button 608 that can be selected by user 112, at 508, to sign up or register with data privacy application 132. Main page 600-1 also includes Send a Card button 610 that can be selected to initiate sending physical mailer 162 in the form of a card to another user 112, which may be done by users who are registered with data privacy application 132 and those that are not. After a user 112 has signed up or registered with data privacy application 132, user 112 may navigate to a “sign in” page 600-2 by clicking a “Sign In” UI element or tab 612 to log into their account with data privacy application 132.

With continuing reference to FIGS. 5 and 6B-D, data of users who sign up or register with data privacy application 132 is added to database 140 and associated data structures 150 are generated and stored to database 140.

For these purposes, at 510, user clicks sign up button 608 and navigates to sign up page 600-2 to enter their e-mail and password data (once or multiple times for verification) into respective data entry fields 614a-c for email, password, and password confirmation. At 512, data privacy application 132 searches database 140 to determine whether an e-mail address entered in field 614a, for example, matches data stored in database 140. Continuing with reference to FIG. 5 and FIG. 6C, at 514, for a new user, user 112 proceeds to enter data such as their name, company name if applicable, and mailing address data into respective data entry fields 616a-i for first name, last name, company name if applicable, street address, city, state, zip code, and country.

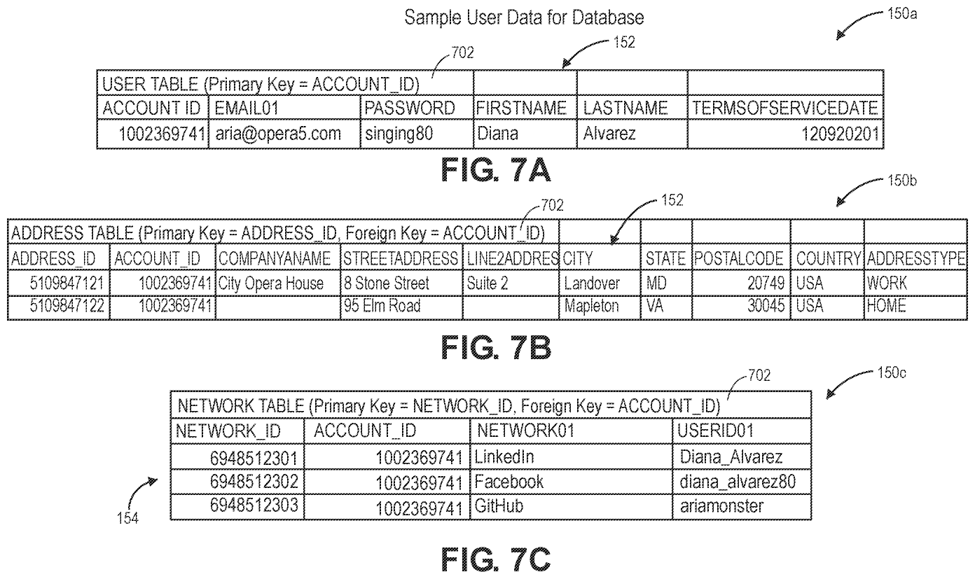

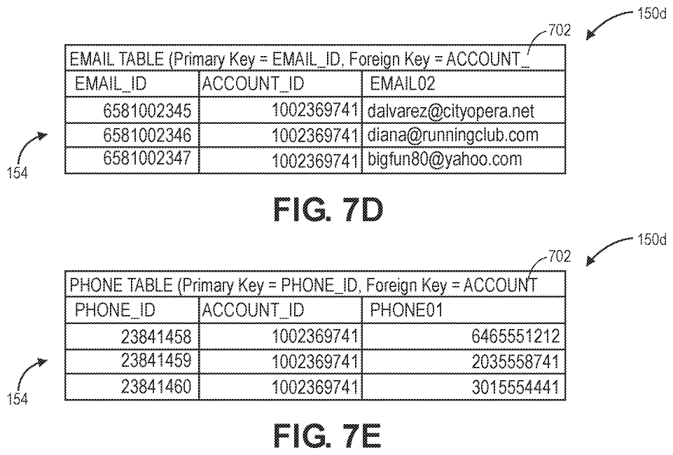

With continuing reference to FIG. 5 and with further reference to FIGS. 7A-E, at 516, data privacy application 132 integrates data entered by user into one more data structures 150 that are stored to database 140. For example, when user 112 clicks “Sign Up” button 608 in page 600-1, data privacy application 132 generates data structures. For example, one data structure 150a includes an account identifier, an email address, password, first name, last name, and date terms of service were agreed to by user, and another data structure 150b includes data such as an address identifier, account identifier, company name (if applicable), and address data for residence and work of an address, city, state, zip code, and country. These data structures 150 may include personal data 152 such as a user's name and/or residence mailing address. Data structures 150c-e may include other data about the user, or additional data 154 about the user, such as social network data (network identifiers, account identifiers, network name and user identifier or screen name), other email addresses and phone number data.

According to one embodiment, and with continuing reference to FIGS. 7A-E, data structures 150 share certain common data but are also segmented to include different types of data. For example, some data structures 150a-b include private personal data 152, whereas data structures 150c-e include identification or known user data 154 that is or may be publicly known and available to be searched by other users of data privacy application 132. Further, data structures 150a, 150b and other data structures 150c-e shown in FIGS. 7A-E include and share a unique, system-generated ACCOUNT_ID 702 for that particular user so that different data structures 150 can be internally linked together. In the illustrated embodiment, ACCOUNT_ID 702 serves as a Primary Key in data structure 150a of “USER TABLE” of FIG. 7A and as a foreign key in other data structures 150b-150e of FIGS. 7B-E.

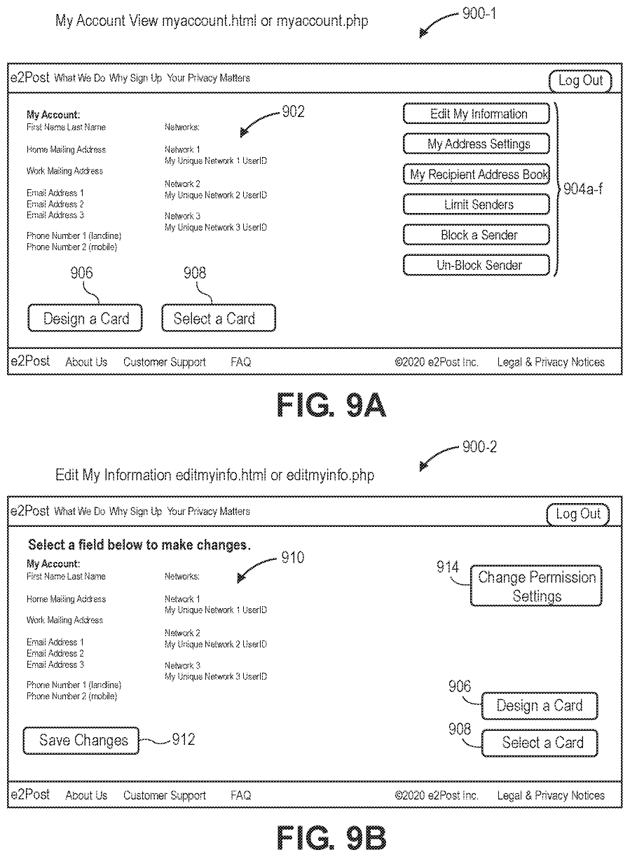

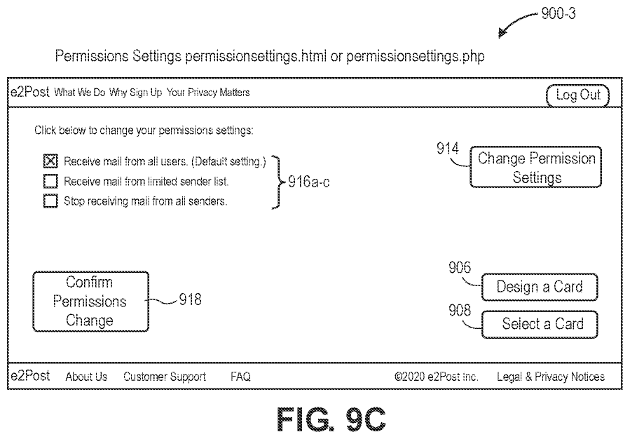

Referring again to FIG. 5 and with further reference to FIG. 6D, at 518, users 112 are encouraged to add additional identification data 154 via pages such as 600-4 of FIG. 6d such as additional email address, phone number, social network, and network ID information into fields 618a-i to enhance searches for user by other users through data privacy application 132. Referring to FIGS. 7C-E, data structures 150c-e may be generated for these purposes. For example, data structure 150c includes searchable social network data, data structure 150d includes searchable e-mail data and data structure 150e includes searchable phone number data, all of which are cross referenced to other data structures 150a-b with ACCOUNT_ID 702. Further, by clicking on “My Account” 620 UI element, tab, or link of FIG. 6D, user 112 may also change settings for their account (FIGS. 9A-C), which may include updated mailing addresses and the addition/removal of email addresses, phone numbers, and online network unique user ID's. Thus, as shown in FIG. 5, at 520, all data structures that are generated by data privacy application 132 (e.g., data structures 150a-e in the illustrated embodiment) are added to database 140 and referenced with associated primary and foreign ACCOUNT_ID 702 keys, and at 522, this completes the user's sign up or registration.

Referring to FIG. 6D, after a user has completed sign up or registration with data privacy application 132, the user can then log into their account and log out from their account with UI elements such as “My Account” 620 UI element, tab, or link and “Log Out” 622 tab, which are then made available to user in page 600-4 after registration. Updates that a user makes to pages 600-1 to 600-4 are captured by web server 132. Once the user agrees to the terms of service, including consenting to receive mail, the user's information is uploaded to database 140 and the user becomes a potential receiving user and a potential sending user through data privacy application 132.

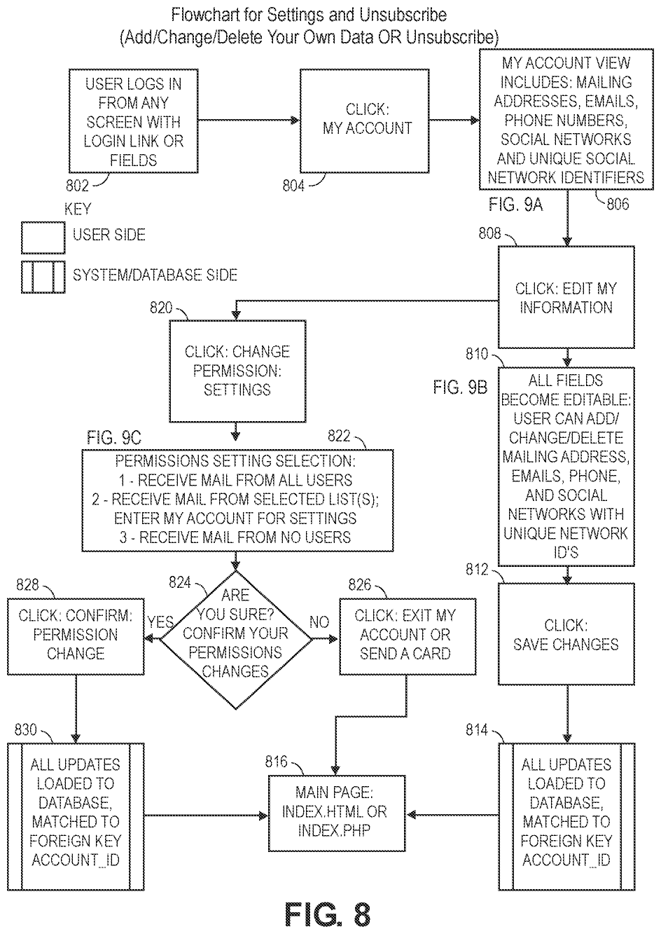

Referring now to FIG. 8 and associated wireframe diagrams of FIGS. 9A-C, users 112 can edit their information in database 140 and change settings to opt out of or opt into receiving mail from other users 112 of computing system 100. For these purposes, referring to FIG. 8, at 802, a user 112 logs into data privacy application 132 from various pages with a “Sign In” UI element or tab 612 such as shown in FIGS. 6A-C described above and then at 804, clicks on My Account 620 in response to which, at 806, data privacy application 132 presents page 900-1 (FIG. 9A) with “My Account View” to user at 806.

As depicted in FIG. 9A, “My Account View” includes information 902 such the user's mailing addresses, emails, phone numbers, social network identifier and unique network ID or username, some of which may be designated as personal data 152, and some of which may be identification or known user data 154. As previously discussed, for ease of explanation, reference is made to a user's name and/or residence address as personal data 152.

Page 900-1 also includes various UI elements or tabs 904a-f that can be selected to edit their information, view their address settings, view their recipient address book, limit senders who can send a user mail, block a sender and un-block a sender. Page 900-1 also includes “Design a Card and “Select a Card” UI elements or buttons 906 and 908 that can be selected to design a card or select a card to be sent to another user of data privacy application 132.

Data privacy application 132 provides users the ability to edit their information at 808 by clicking “Edit My Information” UI element or tab 904a of page 900-1 of FIG. 9A, in response to which, at 810, fields of page 900-2 become editable 910 to allow user to enter changes. At 812, user clicks a “Save Changes” UI element or button 912 and at 814, user submitted changes are uploaded to database 140 via web server 130. At 816, user is then directed to main page 600-1.

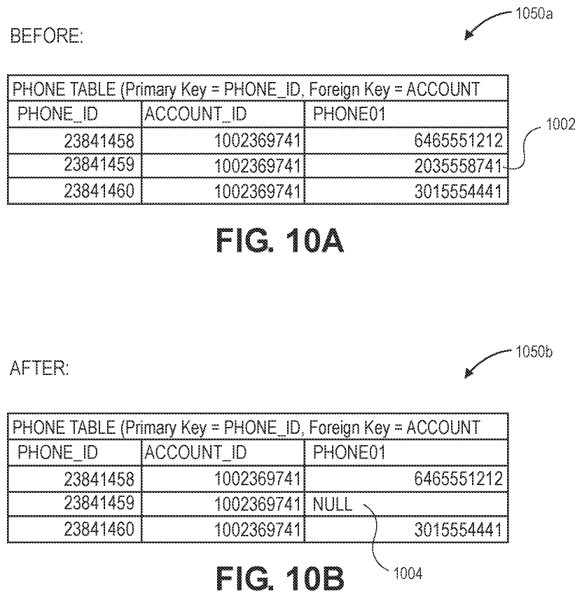

For example, referring to FIG. 10, a data structure 1050a initially includes “Phone 02” of 203-555-8741 1002, but through “Edit My Information” in page 900-1, user deletes that phone number resulting in an updated data structure 1050b in which that phone number is removed, as illustrated by “Null.” 1004.

With continuing reference to FIG. 8 and FIGS. 9B-C, users have the option to change permission settings (e.g., by selecting “Change Permission Settings” UI element or tab 914 of page 900-2 shown in FIG. 9B) to opt in or opt out of services provided by data privacy application 132 and to start to receive or stop receiving mail from other users. Referring to FIG. 8 and FIG. 9C, at 822, page 900-3 is presented to user to allow user to select or unselect various permission options 916a-c of permissions or rules 156, which may include receiving mail from all users (which may be a default setting), only from some users or a limited set of users, or stop receiving mail from all users. FIG. 9C illustrates the default of receiving mail from all users for purposes of illustration. At 824, if changes are made to permission options 916, data privacy application 132 may present a confirmation message to user at 824 that these permission or rule settings are to be changed, and if these changes are not confirmed, then at 826, user can be directed from page 900-3 to another page such as home or main page 600-1 or allowed to send a card via buttons 906 and 908 in page 900-3 that allow user to design or select a card to send to another user. Otherwise, at 828, user confirms changes to rules or permission options 916a-c by pressing Confirm Permissions Change button 918 in page 900-3, and then these permission or rule 156 updates are loaded to database 140 at 830 and user is directed back to home or main page 600-1 at 816 in FIG. 8.

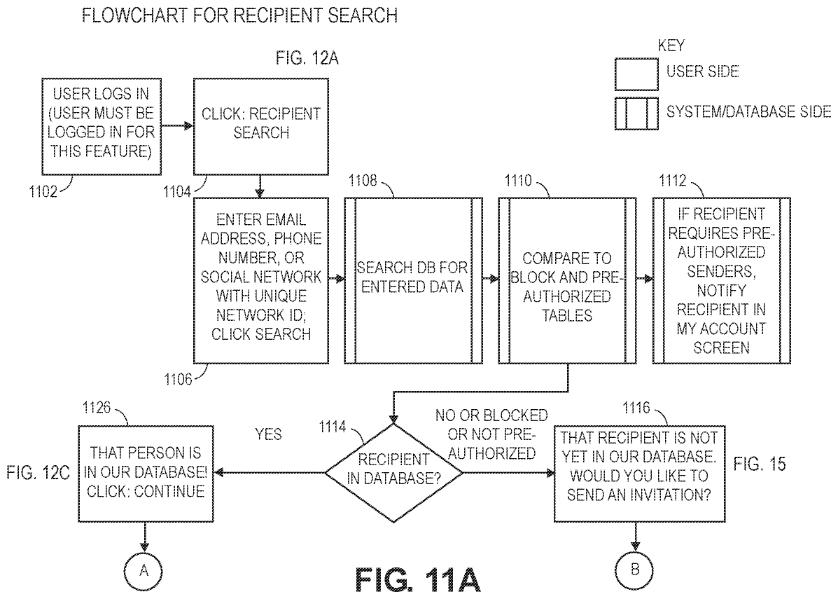

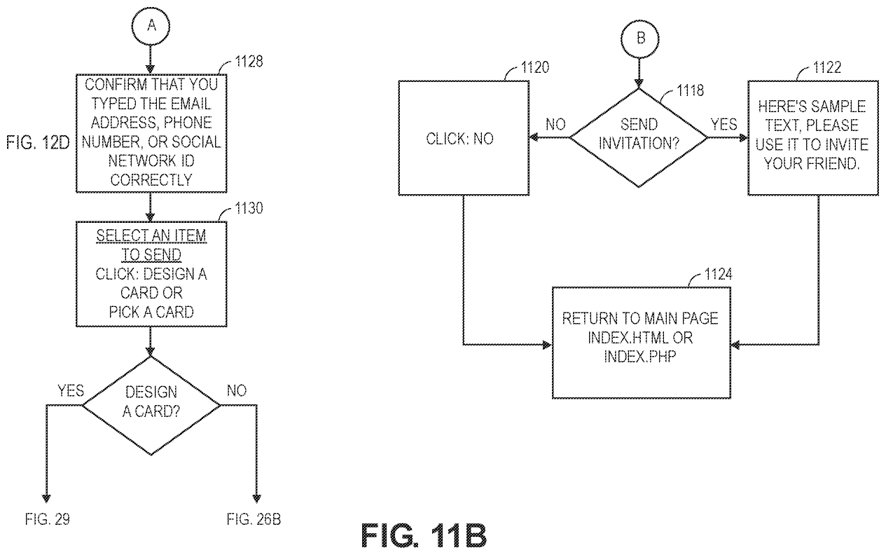

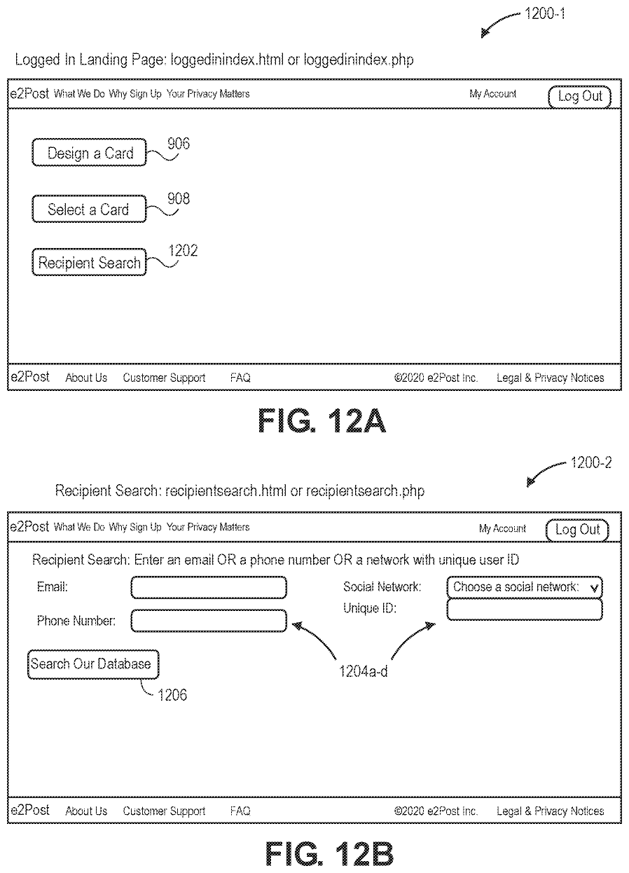

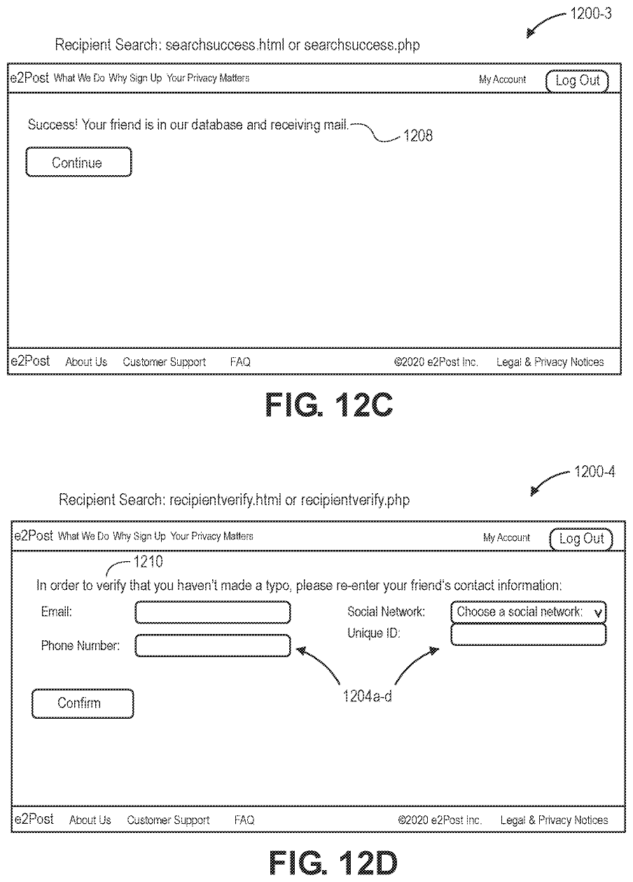

Referring again to step 212 in FIG. 2, and with further reference to FIGS. 11 and 12A-D, further aspects of one manner of searching for information about a receiving user by recipient search 310 are described. A recipient search 310 may only be submitted by a registered user 112 of data privacy application 132.

Referring to FIG. 11, at 1102, user 112 logs into account user has with data privacy application 132 and may be presented with a landing page 1200-1 as generally depicted in FIG. 12A. In the illustrated example, landing page 1200-1 includes previously discussed UI elements or buttons 906, 908 for various actions including designing or selecting a card, and also a “Recipient Search” UI element or button 1202 for initiating a recipient search 310 based on identification data 312 known by and provided by a sending user. At 1104, user clicks “Recipient Search” button 1202, and is directed to page 1200-2 including fields 1204a-d to enter identification data 312 at 1106. In the illustrated example, page 1200-2 includes fields 1204a-d for entry of identification data 312 including a target recipient's email address, phone number, social network or unique identifiers such as a social network user name. It will be understood that these examples of identification data 312 are provided as non-limiting examples of types of data of a first or receiving user 112a registered with data privacy application 132 that may be known by second or sending user 112b to allow second user to conduct recipient search 310.

After entry of one or more types of identification data 312 into one or more fields 1204a-d by second user 112b, second user 112b proceeds to click the “Search Our Database” UI element or button 1206 of page 1200-2, and at 1108, data privacy application 132 searches database 140 to locate another registered user associated with that identification data 132 provided by second user 112b.

For example, second or sending user 112b may provide an email address that is believed to be the email address of another user, referred to as first or receiving user 112a. Data privacy application 132 searches data structures or tables 150 that store email addresses, such as USER TABLE and EMAIL TABLE (examples of which are depicted in FIGS. 7A and 7D), for an email address that matches the email address provided by second or sending user 112b. A database 140 SQL query script for this purpose may be structured in a manner similar to the following: “SELECT * FROM USER WHERE EMAIL01=sample@emailaddress.com”.

With further reference to FIG. 12C, if data privacy application 132 identifies a match of the email address submitted by second user 112b, then second user 112b may be presented with a notification or message 1208 through page 1200-3 that second user 112b can send mail to the identified first user 112a.

For example, if identification data 312 provided by second user 112b is searched and present in database 140, e.g., single cells for mailing address or phone number, two cells in the same row for network with unique user ID, and if associated preauthorized permissions or rules 156 are satisfied (such as if a positive result from the query, the Preauthorized Group database as discussed below is queried, and if that is also positive), then second user 112b may be notified through page 1200-3 that second user 112b can be a “sending” user to send mail to the searched and identified first user 112a. In other words, a user transitions or transforms from a registered user to a second or “sending” user 112b with the capability of sending mail to the searched user who, for purposes of this recipient search 310 and relative to this particular second user 112b, transitions or transforms from a registered user to a first or “receiving” user 112a.

Referring to FIG. 12D, user 112b proceeds to navigate from page 1200-3 to page 1200-4 for an optional second system verification step 1210 asking second user 112b to re-enter first user's 112a email/phone/network and unique userlD in order to minimize user-made typographical errors. This verification can reduce or minimize mail sent inadvertently to the wrong recipient.

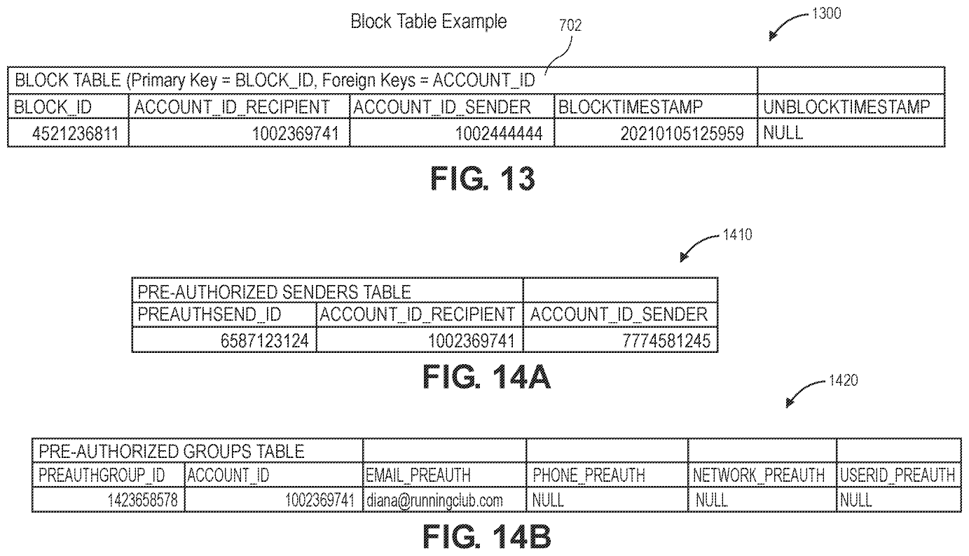

In the embodiment illustrated in FIG. 11 and with further reference to FIGS. 13-14, data privacy application 132 executes preliminary authorization or block checks to determine whether second user 112b is authorized to send, or blocked from sending, mail to first user 112a. Referring to FIG. 11, at 1110, data privacy application 132 searches database 140 for first user 112a and second user 112b, e.g., in a block database table 1300 of FIG. 13, a preauthorized senders database table 1410 of FIG. 14A, and A Preauthorized Group database table 1420 of FIG. 14B. For example, the presence of ACCOUNT_IDs for both first user 112a and second user 112b in the same row of Block database table 1300 of FIG. 13 indicates that second user 112b has been blocked, thereby preventing physical mailer 162 from being sent to first user 112a, whereas presence of ACCOUNT_IDs of both users in same row of preauthorized senders table 1410 of FIG. 14A indicates second user 112b or associated group has been authorized by first user 112, thereby allowing physical mailer 162 to be sent. If first user's 112a email, phone or social network with unique userlD matches anything in preauthorized group table 1420 of FIG. 14B, then physical mailer 162 may be sent.

Data privacy application 132 will notify second user 112b of any related feedback about sending capabilities, but with embodiments, personal data 152 of first user 112a, such as first user's 112 name and/or mailing address, are never shared with or accessible by second user 112b, except if first user 112a specifically provides authorization. FIG. 11 further illustrates optional step 1112 of data privacy application 132 notifying first user 112a about the request if first user 112a requires preauthorized senders.

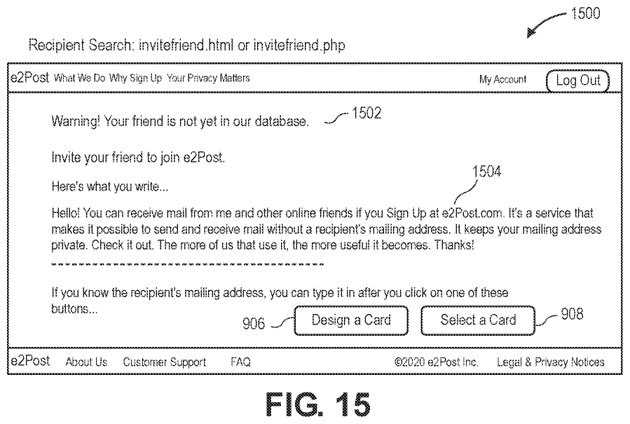

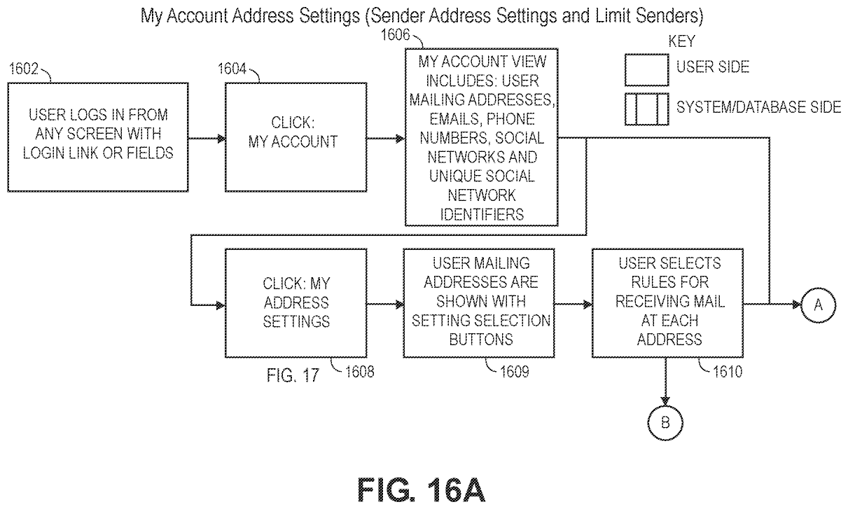

Referring again to FIG. 11, data privacy application 132 determines whether second user 112b is blocked, not included in a preauthorized list or group of senders, or that the target recipient cannot be located in database 140. In these situations, at 1116, data privacy application 132 may present a page 1500 of FIG. 15 to second user 112b notifying 1502 second user 112b who submitted recipient search 310 that the other user he or she is searching for was not located in database 140. In these cases, at 1118, data privacy application 132 presents second user 112b with an option of sending an invitation to the other user or target recipient to sign up with data privacy application 132. At 1120, if the user declines, then at 1124, second user 112b can be directed to another page such as the main page 600-1. Otherwise, at 1122, second user 112b user wants to send an invitation to first user 112a, and data privacy application 132 may present a copy and paste message 1504 through page 1500 that can be emailed, text messaged, or messaged via social network to first user 112a or target recipient. An example of a message 1504 presented to second user 112b is “Here's what you write . . . Hello! You can receive mail from me and other online friends if you Sign Up at e2post.com . . . ). Page 1500 also includes previously discussed UI elements or buttons 906, 908 to allow second user 112b to design or select a card for a person that was not located in database 140.

With continuing reference to FIG. 11 and with further reference to FIG. 12C, at 1126, data privacy application 132 locates first user 112a or target recipient in database 140 and presents page 1200-3 to second user 112b. Page 1200-3 includes a message 1208 that the target recipient was successfully located and receiving mail. At 1128, second user 112b continues to navigate to page 1200-4 and at 1128, confirms that the first user's 112a information is correct by reentering first user's data into respective fields 1204a-d after which at 1130, second user 112b choose whether to design or select a card to send to first user 112a.

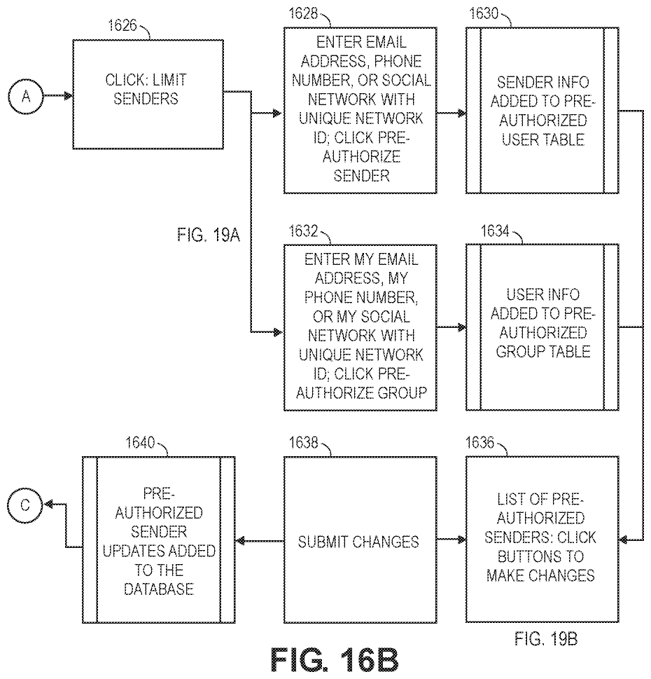

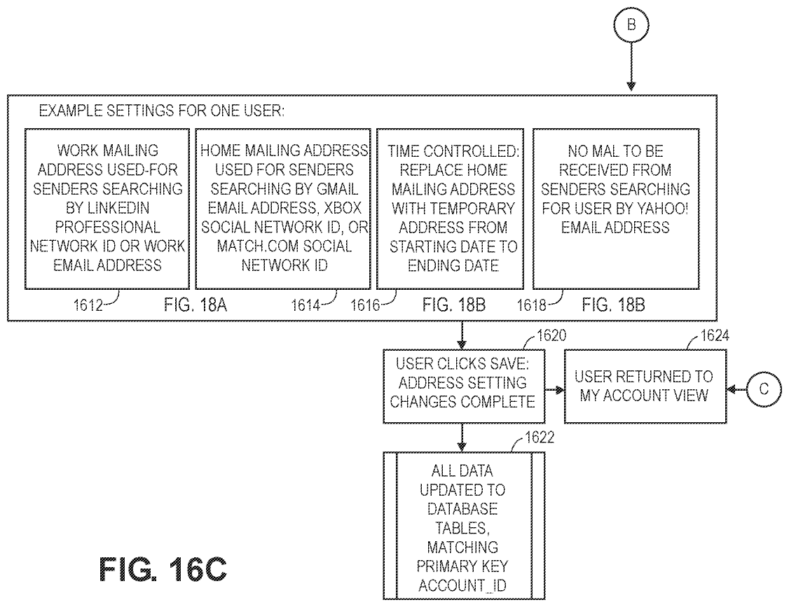

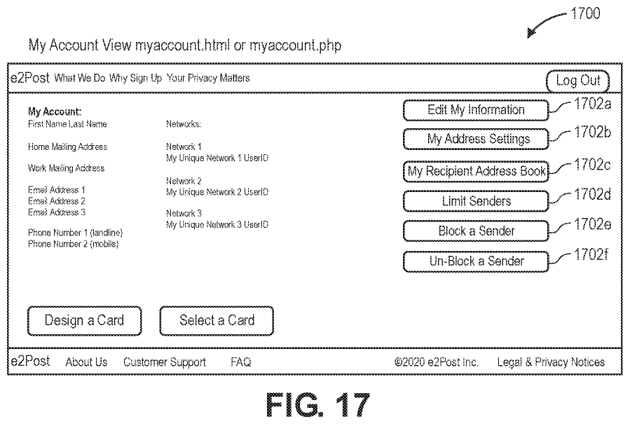

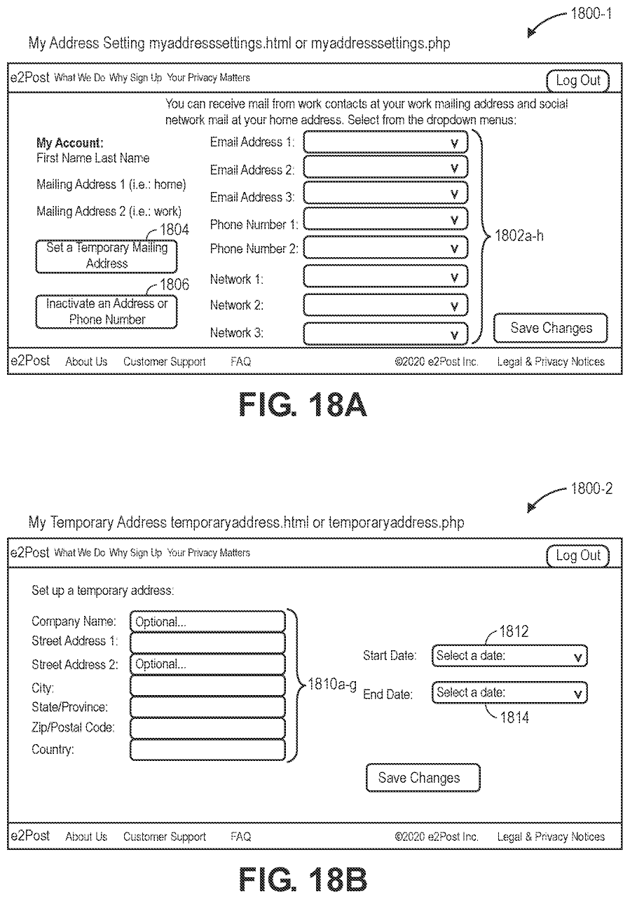

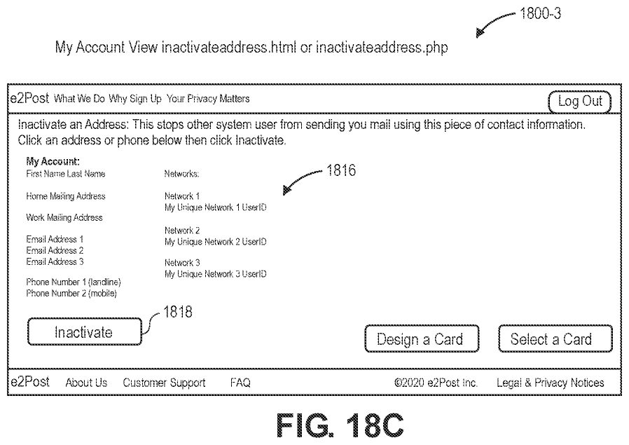

Referring to FIGS. 16A-C, 17 and 18A-C, through data privacy application 132, users are able to control one or more account settings as customized permissions or rules 156 of computing system 100. These permissions or rules 156 may involve controlling how certain addresses are utilized and/or limits on senders. For example, referring to FIG. 16, after logging into data privacy application 132 at 1602 and accessing his or her account at 1604, at 1606, data privacy application 132 presents an account view to user with user mailing address, email, phone number, social network, social network identifier information. At 1608, and with further reference to FIG. 17, a “My Account View” page 1700 with UI elements or buttons 1702a-f for “Edit My Information,” “My Address Settings,” “My Recipient Address Book,” “Limit Senders,” “Block a Sender” and “Un-Block a Sender” is presented to user. User clicks “My Address Settings” UI element or button 1702b and is presented with mailing addresses and setting selection buttons in page 1800-1 of FIG. 18A. Through page 1800-1 and other pages 1800-2 and 1800-3, user can, for example, select permissions or rules 156 for receiving mail at each address at 1610.

FIGS. 16A-C depict one example of how embodiments may be implemented by use of one or more or all of permission or rule settings 1612-1618, and FIGS. 18A-C show how pages 1800-1 to 1800-3 can be configured for user customization of these settings.

Referring to FIGS. 16A-C and FIG. 18A, setting or rule 1612 involves use of a work mailing address to receive physical mailer 162 from senders that locate a user based on identification information 312 of the user's email address or an ID of a particular social networking website such as LINKEDIN professional social networking website. Thus, in this manner, a searcher that locates a user based on work-related search criteria can be directed to, and limited to, contacting a user at a work-related address. Setting or rule 1614 involves use of a home mailing address to receive physical mailer 162 from senders that locate a user based on certain pre-defined identification data 312 such as a particular email address or social network ID of a user. For these purposes, as shown in FIG. 18A, page 1800-1 can include drop down menus 1802a-h for specifying or selecting email addresses, phone numbers and networks and where mail should be received based on the searchers email, phone and network search criteria submitted during a recipient search 310.

Setting or rule 1616 involves time constraints on which address is utilized. Thus, a home mailing address may initially be utilized, but only for a certain time after which a temporary or second mailing address is utilized instead. For these purposes, as shown in FIG. 18A, page 1800-1 can include a “Set a Temporary Mailing Address” button that is selected to direct user to page 1800-2 as shown in FIG. 18B. Page 1800-2 includes fields 1810a-g to specify aspects of a temporary address and drop down date menus 1812, 1814 to specify a date to start using that temporary address of fields 1810a-g and a date to stop using that temporary address of fields 1810 a-g of drop down menus 1802a-h for specifying email addresses, phone numbers and networks and where mail should be received based on the email, phone, and network data of the searcher who submitted recipient search 310.

Setting or rule 1618 involves specifying that no mail or physical mailer 162 should be received from any searcher that locates a user based on certain identification data 312, e.g., based on a searcher using certain email address or phone number located in database 140. For these purposes, as shown in FIG. 18A, page 1800-1 can include a “Inactivate an Address or Phone Number” UI element or button 1806 that is selected to direct user to page 1800-3 as shown in FIG. 18C. User can then set an old email address, phone number, or network with a unique userlD 1816 as invalid or deactivated if they no longer want to receive mail from contacts who might search for them using those types of identification data 312 during recipient search 310. After mailing address settings are entered, the user is asked to confirm changes by pressing “Inactivate” UI element or button 1818 before they are loaded into data structures or tables 150 of database 140.

Referring again to FIGS. 16A-C, at 1620 user saves the settings or rules specified through pages 1800-1 to 1800-3, and these permissions or rules 156 are saved to database 140 to update associated database tables of the user at 1622 as identified by associated ACCOUNT_IDs. User is directed to My Account View (FIGS. 9A) or other page at 1624.

Thus, in view of embodiments described above, registered data privacy application 132 users may select to receive mail at one of multiple addresses (e.g., a home address and a work address). For instance, a user may set a condition for any sending user searching for the user with information 312 of a work email or online professional network unique userlD, that resulting physical mailers 162 should be sent to the receiving user's work mailing address. Users can also set temporary mailing addresses, which may be helpful when a user is travelling for work or away on an extended vacation in which case a temporary work or vacation address may be entered.

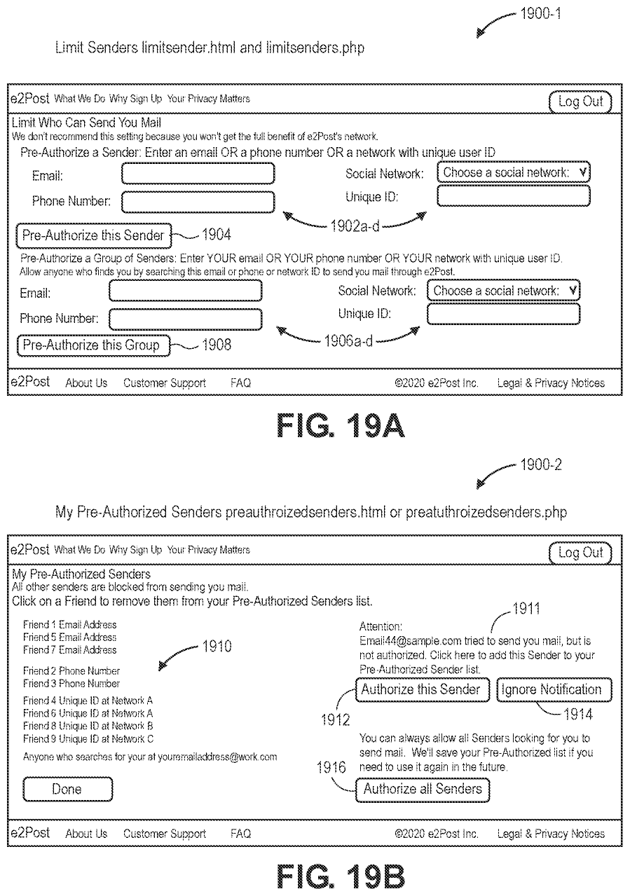

With continuing reference to FIGS. 16 and 17 and with further reference to FIGS. 19A-B, instead of, or in addition to permissions or rules 156 about where a physical mailer 156 is sent, permissions or rules 156 may also limit which senders are eligible to send physical mailer 156 to a user.

At 1626, users may be permitted to pre-authorize select senders in the “Limit Senders” page 1900-1 of FIG. 19A, which is accessed by clicking on the “Limit Senders” UI element or button 1702d of page 1700. At 1628, a user enters data of a sender that is authorized to send a user mail. Sender data may be one or more or all of a sender's email address, phone number, social network and associated social network ID For these purposes, referring to FIG. 19A, page 1900-1 includes fields 1902a-d for a user to enter a sender's email address, phone number, social network and/or unique ID at 1628 to identify an authorized sender, and user then clicks the “Pre-Authorize this Sender” UI element or button 1904 at 1630 to update database 140 information of the preauthorized sender, e.g., as described with reference to FIG. 14A. Similar settings can apply to a group of senders that is authorized to send mail to a user, and page 1900-1 includes associated fields 1906a-d for entry of data of an authorized group of senders at 1632 and a “Pre-Authorize this Group” U I element or button 1908 that is pressed to update database 140 at 1634, e.g., as described with reference to FIG. 14B. For example, a member of a running club may allow anyone using her running club email address to send her mail.

With continuing reference to FIGS. 16A-C, and with further reference to FIG. 19B, at 1636, a list 1910 of preauthorized senders may be presented to user, and page 1900-2 allows a user to execute further permissions or rules 156 by authorizing certain other senders with an “Authorize this Sender” button 1912 in response to a notification 1911 that someone was trying to send mail to a user. User may also ignore such notifications 1911 by pressing “Ignore Notification” UI element or button 1914. User can also allow all senders to mail to a user (rather than using a preauthorized list 1910 of senders) by selecting “Authorize all Senders” UI element or button 1916 instead. These changes are submitted and stored to database at 1638-1640 after which user may be directed to another page such as back to “My Account” view (FIG. 9A).

Thus, with embodiments, a user may decide to receive mail only from a list of preauthorized senders containing specified email addresses, phone numbers, online network with unique userlDs, and/or group affiliations (e.g., current employees of a company, alumni of a school, etc.). In this manner, any sender that submits recipient search 310 searching for a user in database 140 with a specific matching email address, phone number, and/or line network with unique userlD, may send mail to that user.

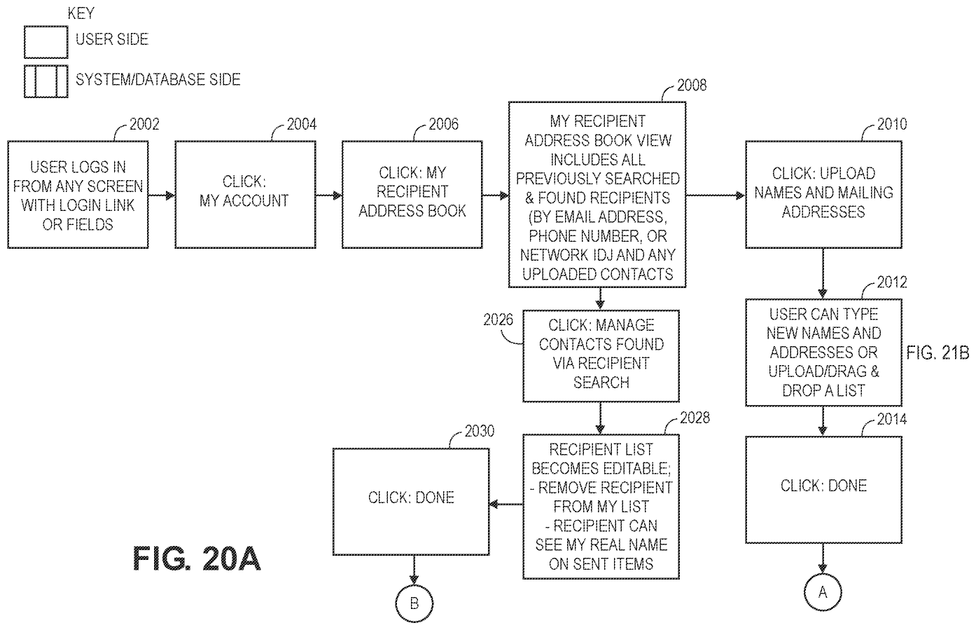

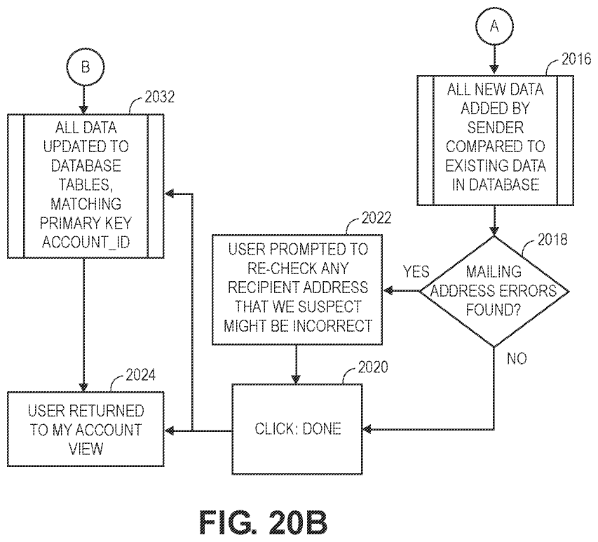

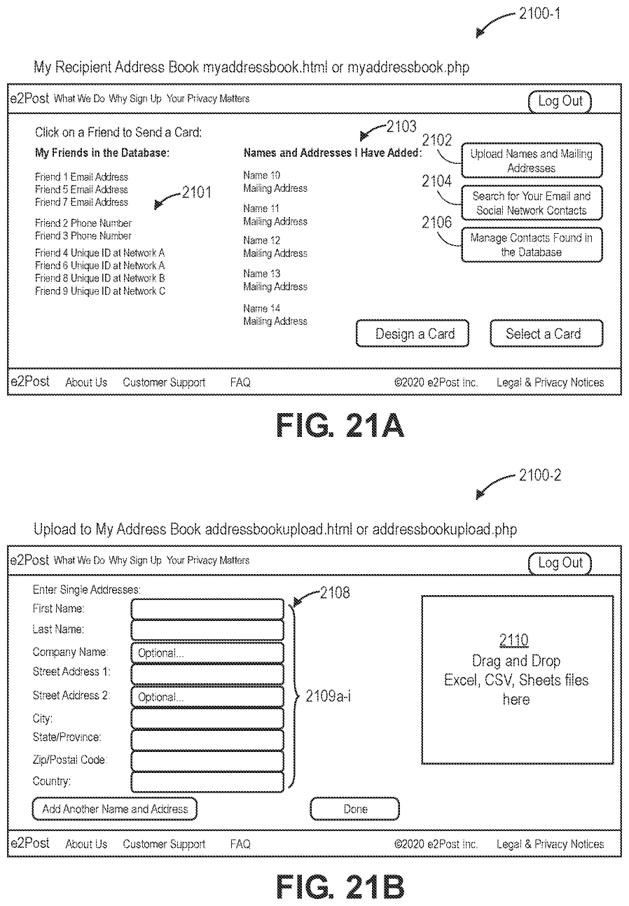

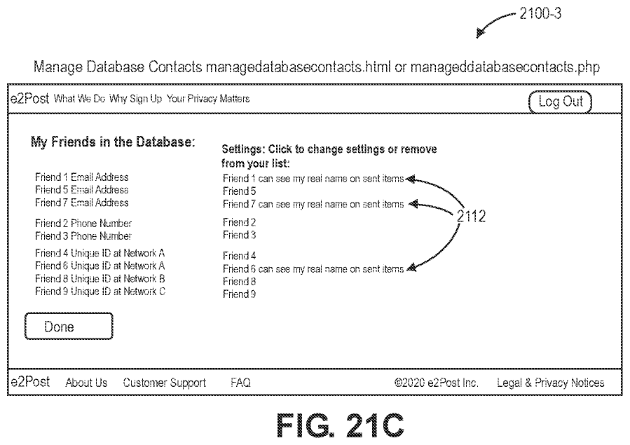

Referring to FIGS. 20A-B and 21A-C, a process for managing contacts who can receive mail from a registered user of data privacy application 132 is described and depicted. Within “My Account” page 1700 of FIG. 17, users have access to their address book via the “My Recipient Address Book” UI element or button 1702c, and the “My Recipient Address Book” page 2100-1 is depicted in FIG. 21A. The address book page 2100-1 includes any contacts that have been uploaded by the user such as contacts uploaded from a spreadsheet of holiday card names and addresses as well as any search and found recipients listed by an identifier (i.e., email, phone number, network with unique userlD, etc.) A new email, phone number, network with unique userlD, or other unique identifier may be added to an existing contact or be used to create a new contact. Address Book contacts are stored in database 140 and accessed via data privacy application 132. The user can click on one or more names or identifiers in their Address Book and then send that user a physical mailer 162 that they select or design. Data uploaded by such second or sending user 112b can also be compared to database 140 and second user 112b is notified if a discrepancy is found in a first or receiving user's 112a information. Without stating the correction, data privacy application 132 may warn second user 112b to check the address before proceeding, or may suggest that there is an alternate address for that recipient within the database. Users can also remove recipients from their Address Book.

Referring to FIGS. 20A-B, at 2002, a user signs into their account with data privacy application 132, navigates to My Account View at 2004 (FIG. 9A); at 2006, navigates to My Recipient Address book by pressing “My Recipient Address Book” UI element or button 1702c in FIG. 17. FIG. 21A depicts page 2100-1 for My Recipient Address Book including a list of a user's friends or contacts in database 140 and names and address of those added 2103. Page 2100-1 also includes UI elements or buttons 2102-2106 for uploading names and mailing addresses, searching emails and social network contacts, and managing contacts found in the database 140.

At 2010, user clicks “Upload Names and Mailing Addresses” UI element or button 2102 in response to which page 2100-2 is displayed to user. At 2012, user may manually enter or type data 2108 into fields 2109a-i or drag and drop 2010 information from an external source such as an Excel, CSV or other electronic file until completed at 2014, after which data privacy application 132 compares new data added to previously stored data in database 140 at 2016. If no errors are identified at 2018, then the check is done at 2020 and user is returned to “My Account View” page 1700 (FIG. 17). Otherwise, at 2022, user is prompted to re-check suspect data until done 2020.

Referring again to FIGS. 20A-B, at 2026, user clicks “Manage Contacts Found in the Database” UI element or button 2106 to manage the contacts found in database 140 and page 2100-3 of FIG. 21C is presented to user. Data privacy application 132 protects privacy of a user's personal data 152 such as their real name and mailing address, and with embodiments shown in FIG. 21C, at 2028, user may edit recipient list and indicate which recipients are able to see the sender's real name, address or other personal data 152 thus providing for controllable and customized data privacy in online computing and physical world environments. In the illustrated embodiment, as indicated by 2112, only Friends 1, 6 and 7 are currently allowed to see a sender's real name, whereas other friends 2-5 and 8-9 are not. When done at 2030, these updates are uploaded to database 140 tables associated with matching ACCOUNT_ID at 2032, and user is returned to “My Account View” page 1700 (FIG. 17).

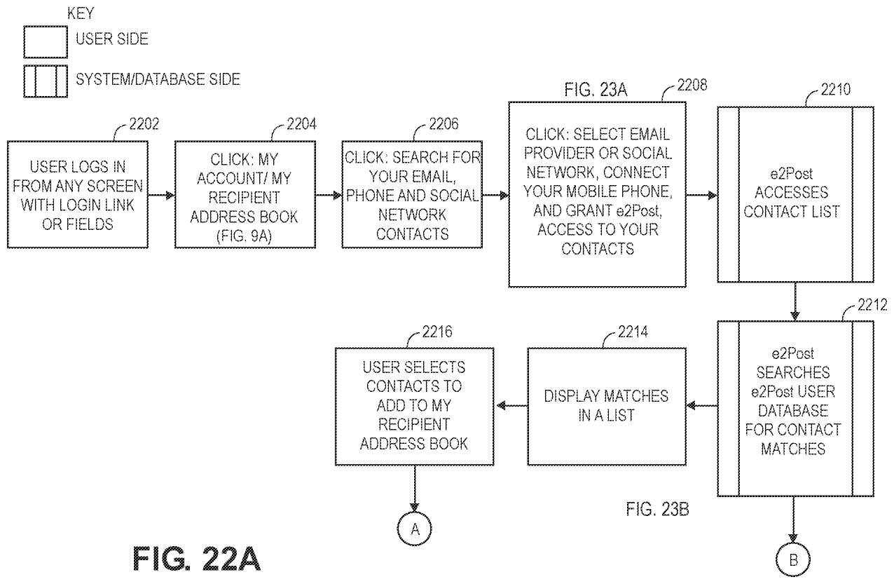

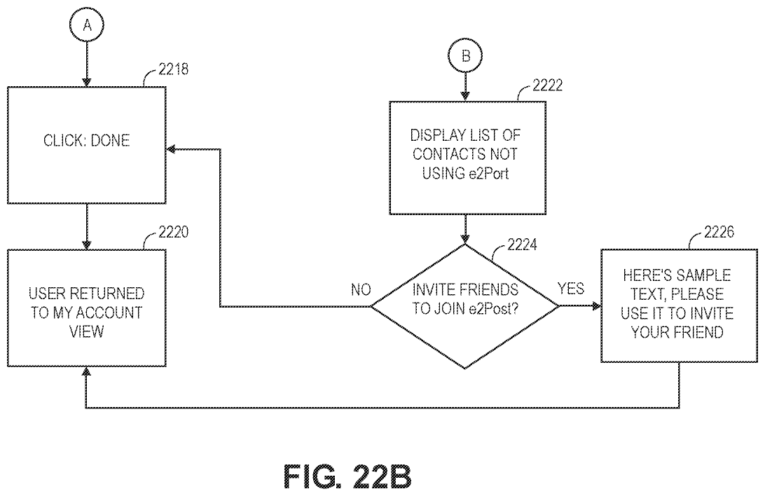

Referring to FIGS. 22A-B and 23A-B, after logging in 2202 and navigating to “My Recipient Address Book” (FIG. 21A) from “My Account View” page 1700 (FIG. 17) at 2204, users may click on “Search for Your Email and Social Network Contacts” UI element or button 2104 (FIG. 21A) at 2206 to be directed to page 2300-1 to allow user to give data privacy application 132 access to the user's contacts of online networks, email lists, phone contacts, etc. At 2208, user selects drop down menu 2302 to select an email provider or social network, or a mobile phone with a provided telephone number, and clicks the “Allow e2Post Access to Contacts” UI element or button 2304 to grant the data privacy application 132 access to the user's contacts hosted by the email provider, social network, mobile phone or other electronic source at 2210. More particularly, user 112 grants access to their network contacts through an Application Programming Interface (API), and clicking the “Allow e2Post to Access Contacts” button 2304 accesses the API and links the network's contacts to data privacy application 132. Data privacy application 132 searches contact list at 2212 and compares contact list data to contact data already stored in database 140.

At 2214, data privacy application 132 creates a list of contacts 2306 including user's friends that are already registered with data privacy application 132, and at 2216, the user can select contacts to add to the Recipient Address Book, after which the contact search process is done 2218, and user is returned to “My Account View” page 1700 (FIG. 17) at 2220. At 2222, data privacy application 132 displays a list 2308 of contacts that are not registered with data privacy application 132, and presents user with an option 2224 of inviting those non-registered friends to join data privacy application 132 by pressing the “Invite These Friends to Join e2Post” UI element or button 2310. If user declines, then at 2218, the contact search process is completed, and user is returned to My Account View page 1700 (FIG. 17). Otherwise, at 2226, data privacy application 132 presents text of a message that can be sent to the non-registered friends (as previously discussed with reference to FIG. 15).

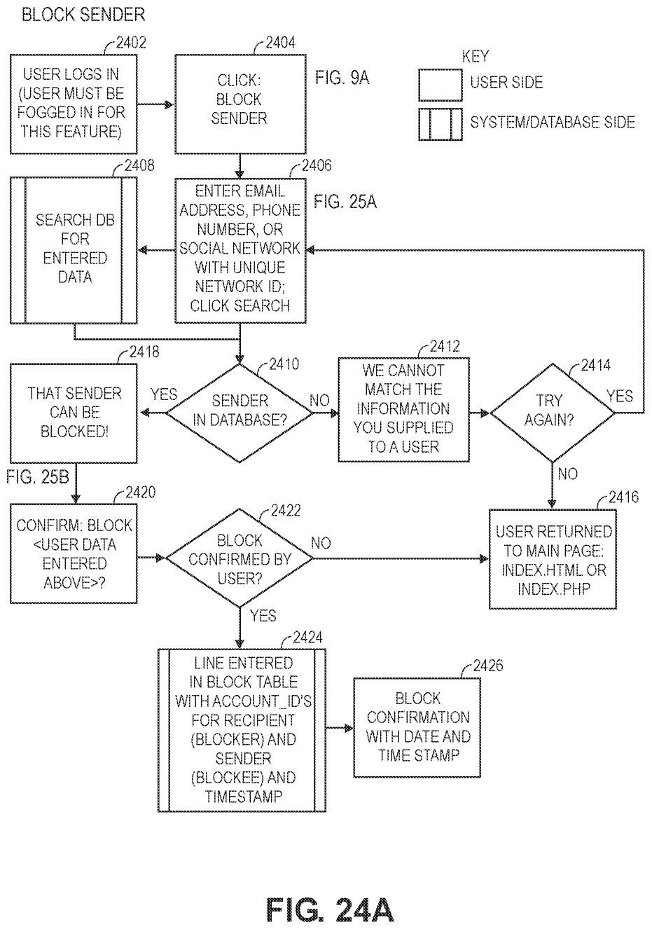

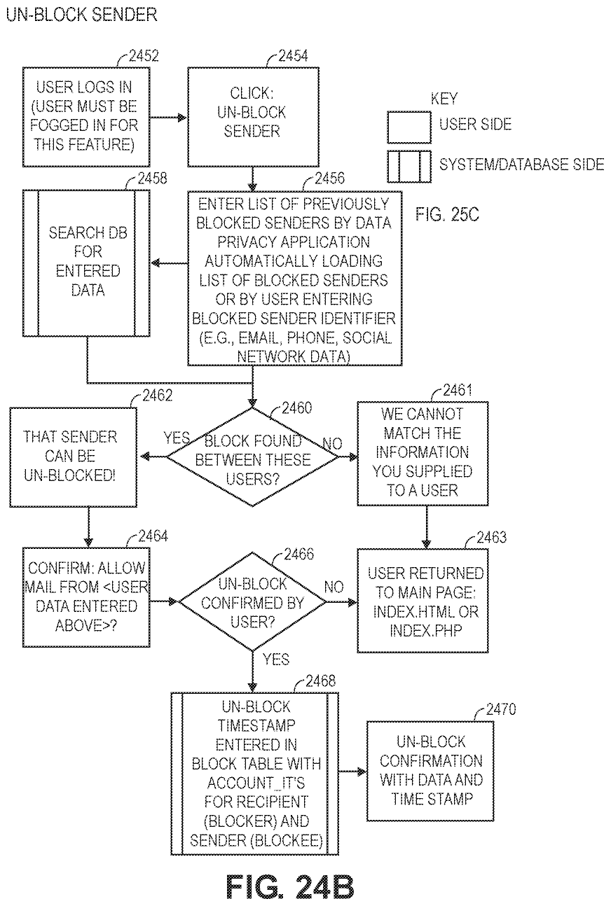

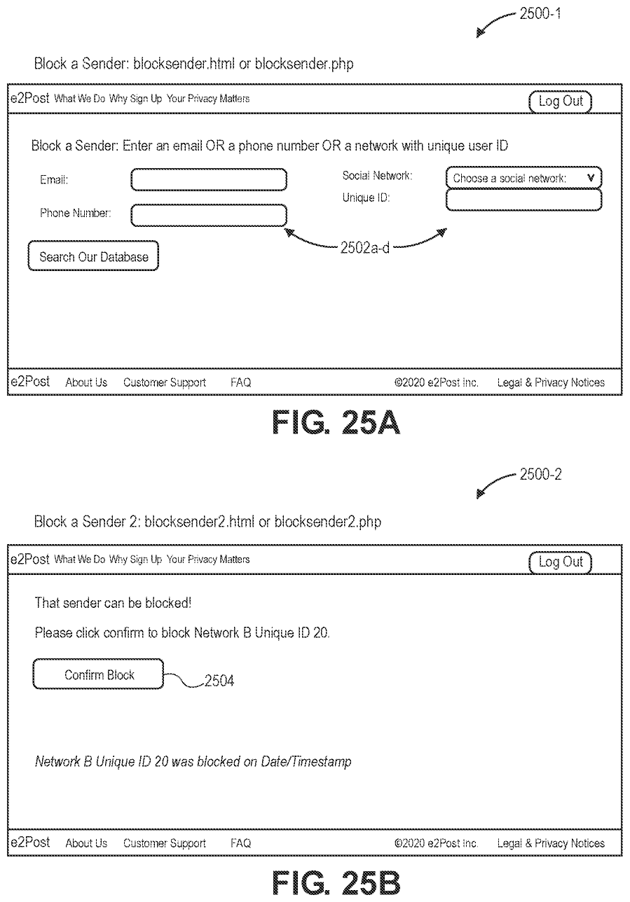

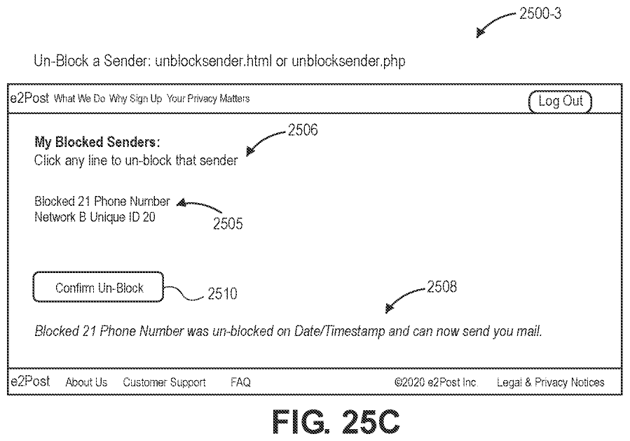

Referring to FIGS. 24A and 25A-C, a registered user of data privacy application 132 may also block mail from a specific sender or block a specific sender from sending anything to the user. User signs into data privacy application 132 at 2402 and is directed to the “My Account View” page 1700 (FIG. 17). At 2204, user can select the “Block a Sender” UI element or button 1702e of page 1700 and enter an identifier for data privacy application 132 to block (e.g., another user's email address, phone number, or online network with their unique userlD). At 2406, and with reference to FIG. 25A, page 2500-1 includes fields 2502a-d that allow a user to enter email, phone number, social network and unique ID identifiers of another user or sender that is to be blocked. At 2408, the entered identifier is provided to data privacy application 132, which searches database 140 for the entered identifier data. At 2410, if the searched user or sender is not identified in database 140, then at 2412, user can be notified that no match was found and asking at 2414 whether user wants to submit other data to block other user or sender. If so, then the process proceeds again to 2406. If not, then at 2416, user can be returned to another page such as a main page (FIG. 6A) or other page. Otherwise, at 2418, data privacy application 132 identifies another user or sender associated with the email, phone number, social network and/or unique ID data that was entered in page 2500-1, and at 2420, presents page 2500-2 to user to allow user to confirm at 2422 that this user can be blocked as a sender. If the user does not confirm blocking, then at 2416, the user is returned to the main page (FIG. 6A) or other page. Otherwise, user confirms blocking of the other user or sender by pressing “Confirm Block” UI element or button 2504, and data privacy application 132 updates database 140 to reflect the blocked sender. For this purpose, referring again to FIG. 13, data structure 1300 of database 140 can be updated to add another user or sender to block table 1300 and add block date and timestamp data at 2426 for the blocked sender. Thus, when a user attempts to send mail, that user's data is compared to data of block table 1300 before that user can send mail.

With continuing reference to FIG. 24B and FIG. 25C, page 2500-3 provides a list 2505 of currently blocked senders to a user while providing the ability to unblock a previously blocked sender by clicking 2506 on a blocked sender in list 2505. The un-block process is similar the previously described blocking process, with a second date stamp for the un-block added to the Block database table 1300 of database 140 as depicted by 2508 in FIG. 25C.

At 2452, user logs into data privacy application 132 and is directed to the My Account View page 1700 (FIG. 17) where the user selects the “Un-Block a Sender” UI element or button 1702f at 2454. At 2456, user is presented with list 2505 of previously blocked senders and select a blocked sender from the list 2505 to unblock. A user may also enter information about a sender to be unblocked and that is identified by, for example, the sender's email address, phone number, or social network with uniquelD. At 2458, the entered identifier data of a blocked sender or the selected sender that is currently blocked is provided to data privacy application 132, which searches database 140 for the entered identifier data. At 2460, if a blocked sender associated with the identifier data is not identified in database 140, then at 2461, user can be notified that no match was found and asked at 2464 whether user wants to submit other data to un-block a sender. If so, then the process proceeds again to 2406. If not, then at 2464, user can be returned to another page such as a main page (FIG. 6A) or other page. Otherwise, at 2462, data privacy application 132 identifies a blocked sender associated with entered email, phone number, social network and/or unique ID data, and at 2464, presents page 2500-3 to user to allow user to confirm at 2464 that this blocked sender can be unblocked. If the user does not confirm unblocking, then at 2463, the user is returned to the main page (FIG. 6A). Otherwise, at 2468, with unblocking confirmed by pressing “Confirm Un-Block” UI element or button 2510, data privacy application 132 updates database 140 to reflect the sender that is no longer blocked from sending mail to the user. For this purpose, referring again to FIG. 13, data structure 1300 of database 140 can be updated to add sender to block table 1300 and add unblock date and timestamp data at 2468. Thus, embodiments provide for selective and controllable sender blocking and unblocking.

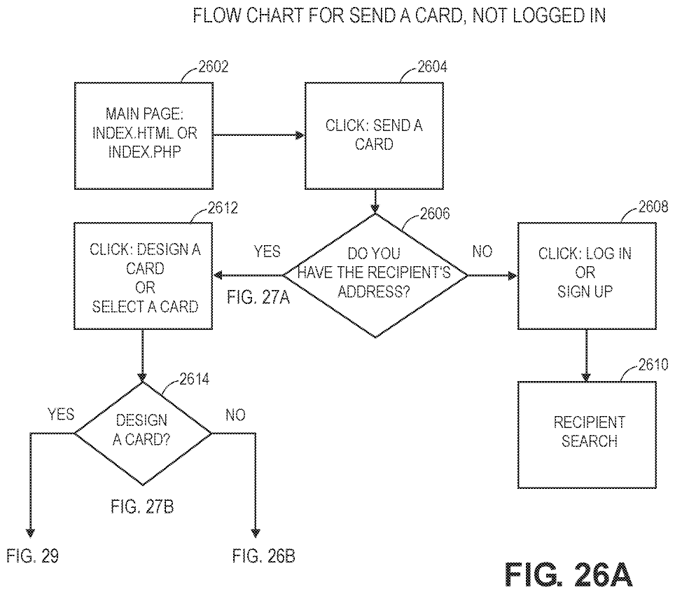

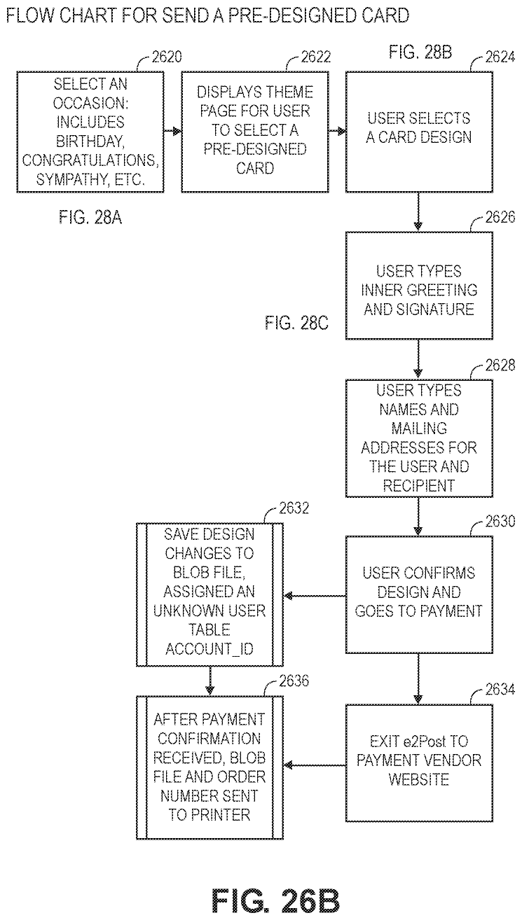

Referring now to FIGS. 26A-B and 27A-B, while data privacy application 132 allows for physical mailer 162 to be sent by a registered sending or second user 112b to a registered receiving or first user 112a while maintaining private first user personal data 152, embodiments also allow for sending physical mailer 162 such as a card by users who have not registered with data privacy application 132. Such users may send a pre-designed card or design their own card. Unregistered users who have not signed up with data privacy application 132 or who are not logged into data privacy application 132 may select or design and ship physical mailers 162, but with limited capabilities and benefits compared to other registered and logged users, and only if additional information is known about the first or receiving user 112a, namely, the first user's 112a name, and mailing address.

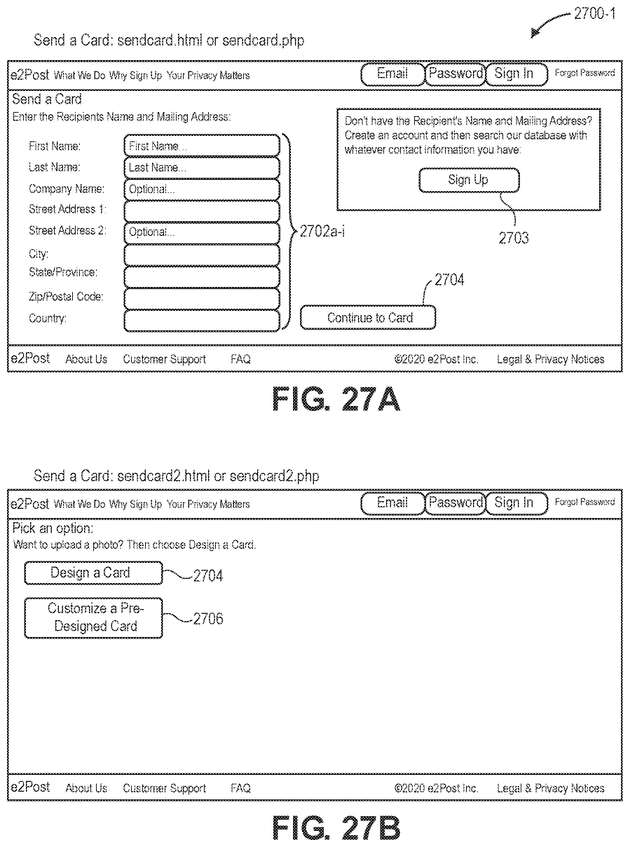

For example, without logging into data privacy application 132, a sending or second user 112b can select the “Send a Card” UI element or button 610 of page 600-1 to be directed to page 2700-1 of FIG. 27A. User proceeds to enter recipient information into data entry fields 2702a-i as appropriate including recipient names and their mailing addresses. The user, while still unregistered or not logged into data privacy application 132, can click “Continue to Card” UI element or button 2704 and proceed to page 2700-2 to click “Design a Card” button 2704 or “Customize a Pre-Designed Card” button 2706 as depicted in FIG. 27B. In one embodiment, if the sending user does not know the recipient's mailing address, then user is invited, via “Sign up” UI element or button 2703, to sign up with or log into data privacy application 132 and enable user to submit a recipient search 310 based on information 312 that the user knows about the recipient.

FIG. 26A illustrates one embedment of a method and how a computing system 100 may provide for pre-designed physical mailers 162 in the form of pre-designed cards (e.g., having a pre-designed shape or template), and instructions for sending the pre-designed card to a recipient. To send a pre-designed card, a sending user, whether or not logged into the computing system 100, and while at main page (FIG. 6A) at 2602, may select the “Send a Card” UI element or button 610 at 2604 and is directed to page 2700-1 of FIG. 27A. Computing system 100 queries user whether user has an address for the intended recipient at 2606. If not, then at 2608, user may log in or sign up with data privacy application 132 as described above, and at 2610, submit a recipient search 310 to search for recipient or determine whether recipient is a registered user of data privacy application 132. Otherwise, if user does have the mailing address for the recipient at 2606, then at 2612-14, user chooses whether to design a card or select a card.

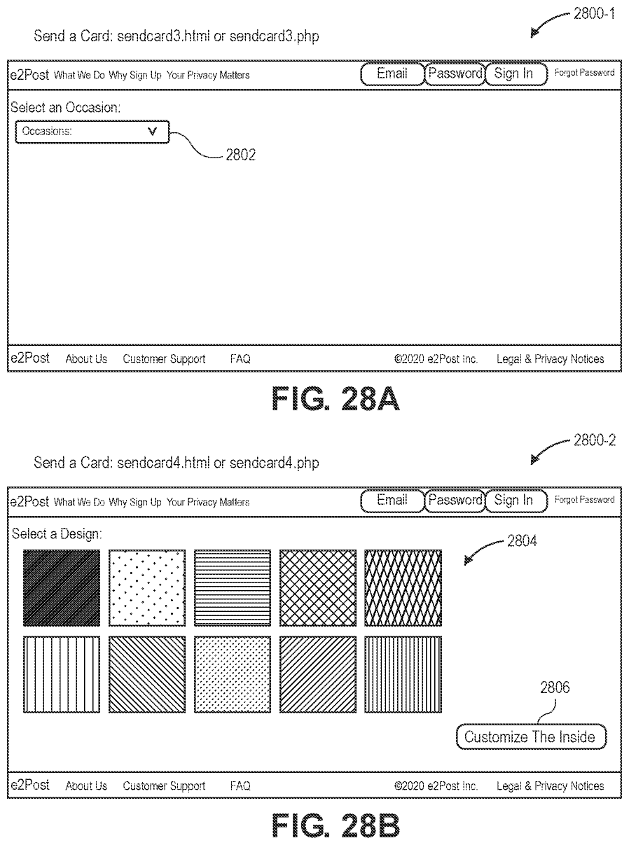

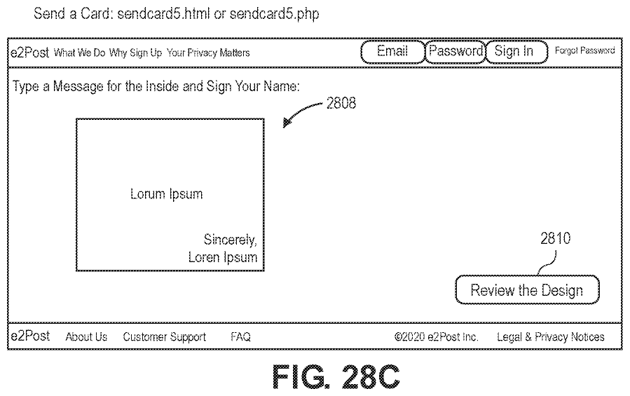

Referring to FIG. 26B and FIGS. 28A-C, for selecting a card, at 2620, user may select an occasion from pull down menu 2802 of page 2800-1 as depicted in FIG. 28A. Examples of occasions include a birthday, anniversary, sympathy or a congratulations. At 2622, computing system 100 displays pre-designed card options 2804 to user (as depicted in FIG. 28B), and at 2624, user selects a card design. With further reference to FIG. 28C, at 2626, user may select “Customize the Inside” UI element or button 2806 of page 2800-2 to add text of a message or greeting and signature 2808 to the inside of the card as depicted in page 2800-3 of FIG. 28C. At 2628, user types user's name and mailing address and the recipient's name and mailing address, presses “Review the Design” UI element or button 2810, confirms the design at 2630 and proceeds to payment for the card. Payment processing can be handled by an external vendor to ensure compliance with security concerns and/or government regulations.

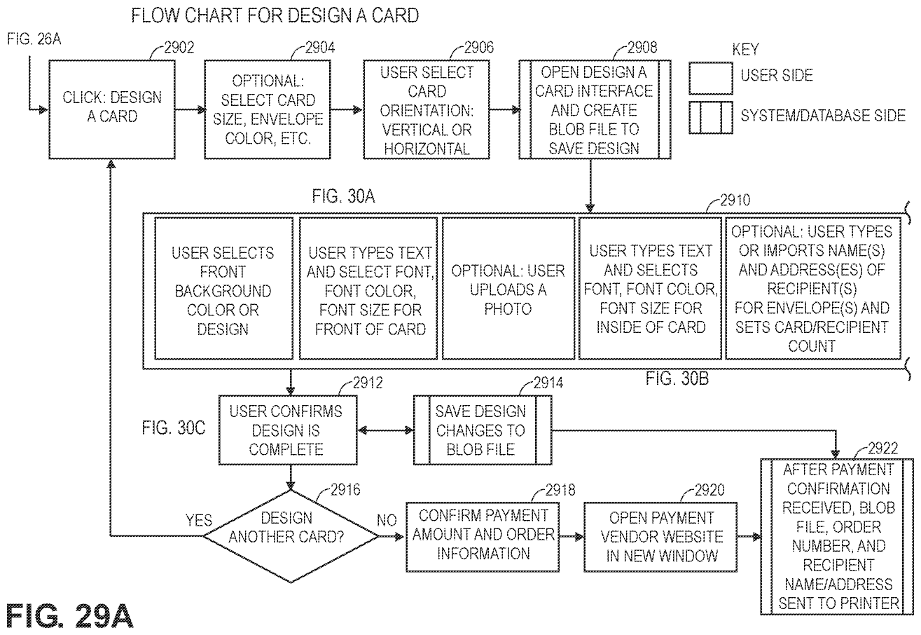

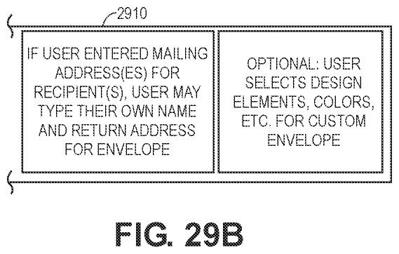

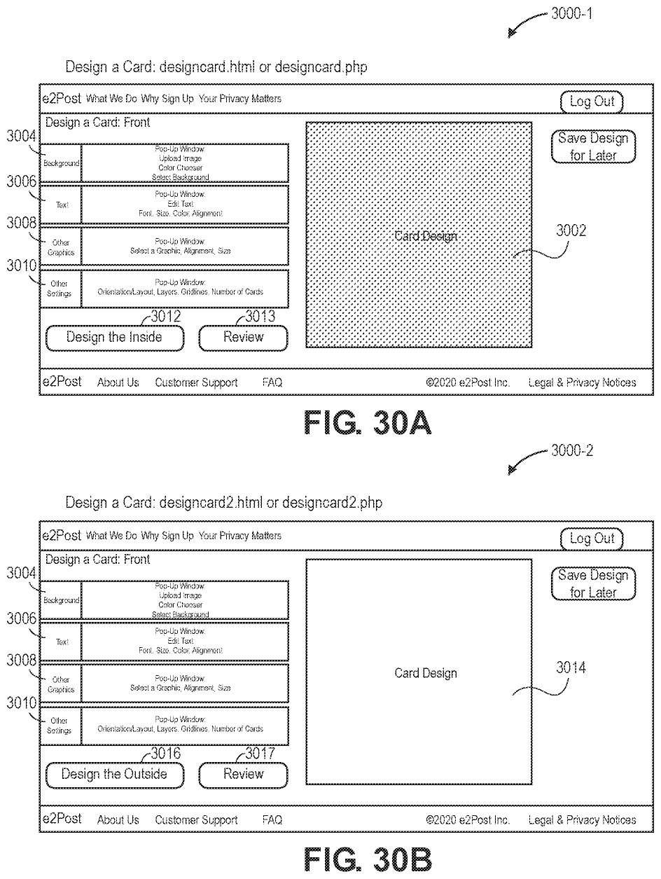

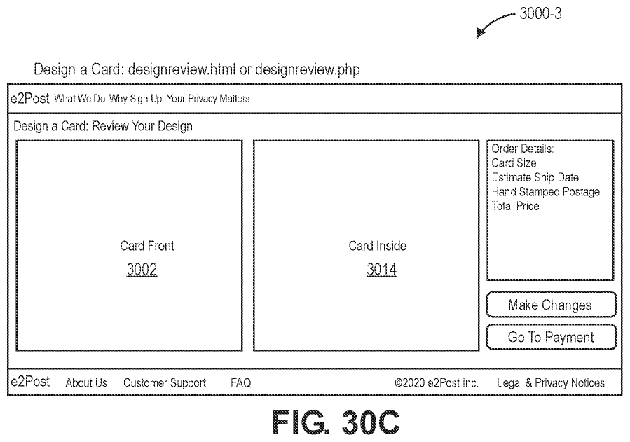

At 2632, computing system 100 saves the card design in an electronic format, such as a Binary Large Object (BLOB) file, which is assigned an unknown user table ACCOUNT ID. At 2634, user exits the computing system 100 and proceeds to a payment vendor website, and at 2636, BLOB file and an order number is sent to a printer 160 after payment has been confirmed. Referring to FIGS. 29 and 30A-C, when a user chooses to design a card rather than select a card as previously described with reference to FIGS. 28A-C, at 2902, user selects the “Design a Card” UI element or button 2704 (FIG. 27B), and at 2904 and 2906, as necessary, selects a card size, fold, orientation, envelope color, card orientation (vertical or horizontal) and other card/envelope configurations attributes. In one embodiment, a custom printed envelope may be used.

At 2908, computing system 100 opens an interface for card design and creates an electronic file such as a BLOB file for saving the design. At 2910, through interface pages 3000-1 and 3000-2, user interacts with various card/envelope design tools to design the front of the card (FIG. 30A) and the inside of the card (FIG. 30B). For example, block 2910 of FIG. 29 includes various design steps or options including selection of a front background color or design, a type of text, font, font color, font size, a photo if the card is to include a photo. The user then types text and selects the font, color and size for the front of the card and may also type or import names and addresses of recipients for envelopes and sets of card/recipient count and enters they name and other design attributes as needed. For these purposes, referring to FIG. 30A, the front of the card to be designed is depicted as 3002, and the user may employ one or more design tools 3004, 3006, 3008, 3010 for designing the front card background, text, graphics and for other front card design settings. User may also upload an image for the front of the card. The user can review the front card design by pressing the “Review” UI element or button 3013. Design tool 3004 provides background design options, design tool 3006 provides text options, design tool 3008 provides graphics options, and design tool 3010 provides for other design settings and configurations.

When completed with designing and review of the front of the card 3002, user may select the “Design the Inside” UI element button 3012 of FIG. 30A to proceed with designing the inside of the card 3014 with similar design tools 3004, 3006, 3008, 3010 and reviewing same by pressing the “Review” UI element or button 3017. User may also scan or image a handwritten message and/or signature for inclusion in the card. When completed with designing and review of the inside of the card 3002, user may go back to the outside of the card by selecting the “Design the Outside” UI element or button 3016 of FIG. 30B. The card front 3002 and inside 3014 can be reviewed together in page 300-3 of FIG. 30C.

Referring again to FIG. 29A, at 2912, after the front and inside card designs have been completed and there are no further changes, the computing system 100 saves the card design to BLOB file at 2914, and if no additional card is to be designed at 2916, then at 2918, then the payment amount and order information is confirmed, and computing system communicates with a payment website at 2920 to process user's payment. After 2922, once payment is confirmed, the order information and design (e.g., one or more PDFs or BLOBs) are complied, assigned an order number, and small barcode or other unique tracking identifier for tracking, and are sent to printer 160 for printing.

Referring to FIG. 30A, user selects the decoration for the front of the card: background, text, uploaded photo(s), graphics and determines sizing, fonts, colors, and orientation. If the card has not been pre-selected for a recipient, the sending user is then prompted to enter one or more names and addresses or to select one or more recipients from their Address Book as described with reference to FIG. 20A. Details are displayed for the user's confirmation as depicted in FIG. 30C, then the sending user's web page directs the sending user to payment processing with an external vendor.

Having completed a design or selection of a physical mailer 162 such as a card, data privacy application 132 compiles data to generate mailer data 158 that is sent to printer 160. FIG. 31 illustrates one example of mailer data 158 for embodiments in which a registered user as a second or sending user 112b is sending a physical mailer 162 to a first or receiving user 112a. In the illustrated embodiment, mailer data 158 includes an order number 3102, timestamp data 3104, data of physical mailer 162 in an attached design file such as a BLOB file 3106, sender information 3108, and recipient information 3110. With embodiments, data privacy application 132 includes personal data 152 of first or receiving user 112a, but this personal data 152 is not disclosed or accessed by first or sending user 112b. For example, the recipient's or first user's personal data 152 may include the first user's mailing address (e.g., 84 Redwood Lane, Sequoia Park, Utah 84552), or a combination of the mailing address and the first user's name (e.g., Sharon Dale).

FIG. 31 also illustrates an embodiment in which personal data 152 of a name of the second or sending user 112b (e.g., identified by an email address of yogurtfan@gmail.com 3112 rather than by second user's 112b real name) is also protected such that the second user's name is not included in physical mailer 162 or on envelope 164. Rather than use second user's 112b residence address as a return address, the return address may be an address of the computing system 100 host 3114 if first user 112a was found via recipient search 310 submitted through data privacy application 132. In these cases, the return address may be second or sending user's 112b real name (or other identifier such as a phone number, unique network user ID or email address 3112 as shown in FIG. 31) (do) the computing system 100 company's physical mailing address. Thus, depending on how first user 112a was identified, second or sending user's personal data 152 may or may not be included in a return address of the physical mailer 162 or printed on envelope 164. Second user 112b can specify their name and address be included, or only their name and the address of the host of computing system 100. On the other hand, if second user 112b already knows and enters a first user's 112a name and address, second user 112b can also add their own name and return address to envelope settings.

Thus, second user 112b and/or first user 112a may be provided with certain data privacy or degrees of anonymity, and second user's 112b mailing address, and not only the first user's 112a mailing address, may be protected against disclosure to the other user. In certain embodiments, second or sending user 112b may choose between using the company's return address or their own physical mailing address. Thus, with these embodiments, second user 112b is able to send first user 112a physical mailer 162 while not knowing first user's personal data 125 (such as mailing address), and at the same time, first user 112a receives physical mailer 162 from second user 112b who remains anonymous and does not disclose their name or mailing address to first user 112a.

FIGS. 32-33 illustrate examples of how physical mailer 162 in the form of a greeting card is printed based on the mailer data 158 described with reference to FIG. 31, subsequently structurally modified (e.g., cut, folded) as necessary for insertion into an envelope 164 as needed for mailing and delivery to first or receiving user 112a.

Printing may occur as part of the computing system on-site, or remotely at an external vendor. According to one embodiment, the mailing address of first or receiving user 112a is determined and a local printer 160 identified in that area so that the resulting mailer 162 is printed and processed for shipping from a location local relative to first user 112a to provide for more efficient shipping and delivery.

FIG. 32 illustrates one example of a processing system 3200 for generating physical mailer 162 based on mailer data 158 received from computing system 100, modifying physical mailer 162, and preparing physical mailer 162 with envelope 164 for mailing or shipping. In the illustrated example, system 3200 includes printer 160, mailer modification system 170 (which may be used to process physical mailer 162 and envelope 164 or other package as needed), and insertion machine 172.

Printer 160 may include a database 3202 that receives mailer data 158 from computing system 100 through network 161 (depending on remote or local configuration), queueing computer or server 3204 and a printing press 3206 controlled by a printing press computer 3208 and fed with stock from a paper supply 3210. Printer 160 generates physical mailer 162 based on mailer data 158, and if necessary, physical mailer is provided to mailer modification system 170 so that the shape, size or other structural configuration of physical mailer 162 can be modified to generate modified physical mailer 162m (“m” referring to “modified”). Mailer modification system 270 may also generate or modify envelope 164 to form modified envelope 164m corresponding to modified physical mailer 162m. In the illustrated example, mailer modification system 170 includes one or more cutting machine 3210 such as a guillotine cutting machine and a straight knife cutting machine that output cut physical mailer 162m that may also be provided to score and fold machine 3212 for further modification to score and/or fold physical mailer output by cutting machine 3210. Cut envelope 164m generated by cutting machine 3210 may also be processed by other components as necessary such as a die cut machine 3214, an envelope converter machine 3216 for application of gum or adhesive and to fold envelope. The resulting modified physical mailer 162m and modified envelope 164m are provided to insertion machine 172 to generate a packaged mailer 3220 including the modified physical mailer 162m inserted into modified envelope 164m. Packaged mailer 3220 is then provided to postal system 174 for application of postage 176 onto packaged mailer 3220, and the packaged mailer 3220 with postage is then sorted 3230 as necessary for shipping and delivery by a delivery service such as United States Postal Service (USPS). It will be understood that embodiments may involve some or all of the components described with reference to FIG. 32, and that various modifications to physical mailer 162 and envelope 164 may be performed using various modification devices.

FIG. 33 is a flow chart with further details of how physical mailer 162 and corresponding envelope 164 may be generated and processed for mailing with reference to various components described above with reference to FIG. 32. Numerical component references in FIGS. 1 and 32 and are provided in FIG. 33 for reference.

Referring to FIG. 33, at 3302, mailer data 158 as described with reference to FIG. 31 is received at or uploaded by printer computer 160 (generally, printer 160) from data privacy application 132/database 140, which may be through network 161. At 3304, printer 160 determines whether mailer data 158 includes valid data. If not, printer 160 returns to start and may notify computing system 100 of same. With valid mailer data 158, at 3306, printer 160 places order in queue at 3308 with queueing computer 3204 until printing is ready to begin. Queueing computer 3204 may sort the orders, for example, by zip code.

At 3310, digital graphics files of mailer data 158, which may be for a card or also for an envelope if needed, are sent to composition software of printing press computer 3208 for printing. At 3312, raster image processor of or utilized by printing press computer 3208 is used to convert digital graphics files as needed in preparation for printing by printing press 3206 at 3314. For this purpose, at 3316, resulting electronic print files are loaded to digital press computer and then printed by printing press 3206 at 3214. For the printing of physical mailers 162 in the form of greeting cards, various hardware and software may used. For example, vendors for digital press machines for printing include iGen 5 Press by Xerox Holdings Corporation of Norwalk, Conn., USA and Indigo 1200 Digital Press by Hewlett-Packard Development Co LP of Dallas, Tex., USA.

At 3316, the resulting physical mailer 162 output by printer 160 is provided to one or more cutting machines, which may also be used to cut or generate envelope 164. At 3318, a physical mailer 162 in the form of a card may be provided by printing press 3206 to cutting machine 3210 (such as guillotine and straight knife cutting machines), and then further processed by score and fold machine 3212 at 3320 to reshape or resize card. An envelope 164 may be generated or modified by cutting machine 3210 and subsequently modified by die cut machine 3214 at 3322 and envelope converter machine 3324 for application of gum or adhesive and envelope folding.

Examples of paper cutting machines include Polar N 115 by Polar Group of Hofheim, Germany. Paper folding machines include T 50 Buckle Folder by MBO America Co Ltd of Marlton, N.J., USA.

The resulting modified physical mailer or card 162m and modified envelope 164m corresponding to modified card 162m are provided to inserter machine 172 at 3326. The Physical mailer or card 162m is matched with the correct envelope 164m, using a small bar code or other unique tracking identifier for matching identification, and inserted into the envelope 164m by insertion machine 172. The generated result is a packaged mailer 3200 that includes a card inserted into an envelope.

Examples of inserting machines 172 include Pulse by BlueCrest of Danbury, Connecticut, USA. Mail production management software includes: BCC Mail Manager by BCC Software of Rochester, N.Y., USA; S.M.A.R.T. by Quadient of Bagneux, France; and SendPro by Pitney Bowes of Stamford, Connecticut, USA. Graphics management products include: Adobe Creative Cloud by Adobe, Inc.; Producer bundle by FusionPro, part of MarcomCentral which is owned by Ricoh Company Ltd. of Tokyo, Japan. Printing cameras include Discovery Multiscan by Lake Image Systems Inc. of Henrietta, N.Y., USA.

At 3328, after insertion machine processing to generate a packaged mailer 3220, postage 176 is added by a postage system 174 or by hand or by an external system or party, e.g., depending on where printing occurs, and the greeting cards are prepared for delivery to the USPS or other delivery service. Cameras may be used along the printing process for image-based inspection and verification that cards and envelopes are properly placed together. With postage applied, the packaged mailers 3220 are then sorted as necessary in preparation for mailing and delivery by USPS or other service.

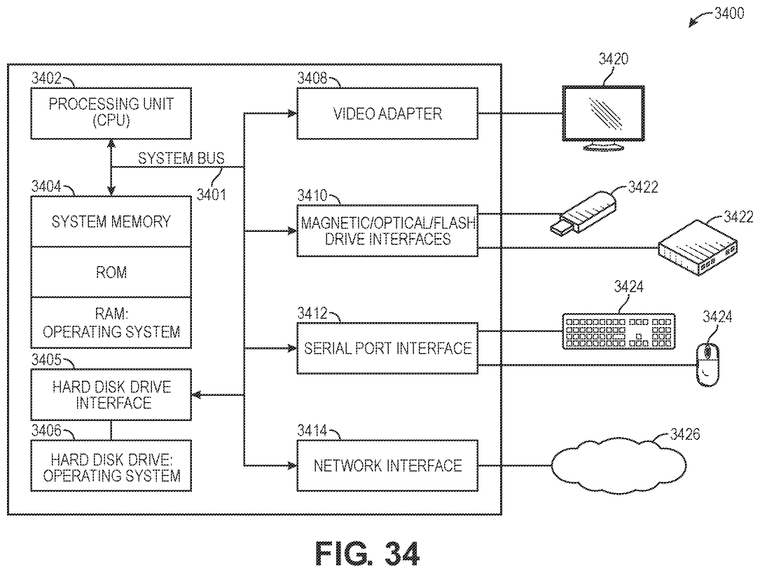

FIG. 34 generally illustrates certain components of a computing device 3400 that may be utilized to execute or that may embody components of embodiments. For example, web server 130 and other computing components such as user computing device 110 and laptop computing device 182 may be configured with computing components described with reference to FIG. 34.

Computing device 3400 may include one or more processors or CPUs 3402, in communication via a system bus 3401 with other components or component interfaces including memory 3404 (such as system memory, ROM, RAM, SRAM, DRAM, RDRAM, EEPROM) a data store 3406 such as a hard drive disk through a hard disk drive interface 3405, a video adapter 3408 for a display screen 3420 to present images and UI screens on a display, magnetic/optical flash driver interfaces 3410 for removable storage or flash drives 3422, a serial port interface 3412 for input devices 3424 such as a mouse and keyboard, and an interface 3414 to a network 3426 such, e.g., for Internet connection 120 or network 161 communications between computing system 100 and printer 160. Network interface 3414 may, for example, be an Ethernet interface, a Frame Relay interface, or other interface. Network interface 3414 may be configured to enable a system component to communicate with other system components across a network which may be a wired or wireless or with various other networks.

Method embodiments or certain steps thereof, some of which may be loaded on certain system components, computers or servers, may also be embodied in, or readable from, a non-transitory, tangible medium or computer-readable medium or carrier, e.g., one or more of the fixed and/or removable data storage data devices and/or data communications devices connected to a computer. Carriers may be, for example, magnetic storage medium, optical storage medium and magneto-optical storage medium. Examples of carriers include, but are not limited to, a floppy diskette, a memory stick or a flash drive, CD-R, CD-RW, CD-ROM, DVD-R, DVD-RW, holographic devices; magneto-optical media; and hardware devices that are specially configured to store and execute program code, such as programmable microcontrollers, application-specific integrated circuits (“ASICs”), programmable logic devices (“PLDs”) and ROM and RAM memory devices, and other carriers now known or later developed capable of storing data.

Embodiments may be implemented utilizing computer code may include machine code, such as produced by a compiler or other machine code generation mechanisms, scripting programs, and/or other code or files containing higher-level code that are executed by a computer using an interpreter or other code execution mechanism. For example, some embodiments may be implemented using assembly language, Java, C, C#, C++, scripting languages, and/or other programming languages and software development tools as are known or developed in the art. Other embodiments may be implemented in hardwired circuitry in place of, or in combination with, machine-executable software instructions.

Although particular embodiments have been shown and described, it should be understood that the above discussion is not intended to limit the scope of these embodiments. While embodiments and variations of the many aspects of the invention have been disclosed and described herein, such disclosure is provided for purposes of explanation and illustration only. Thus, various changes and modifications may be made without departing from the scope of the claims.

Further, given the computer-centric and network and computer centric nature of embodiments and technological, database, and network based improvements provided by embodiments, no claim is intended to cover any mental process, consistent with the nature of embodiments and operation of same and resulting technological and data privacy improvements provided by embodiments across online and physical world environments.

Moreover, while technological improvements and advantages and new capabilities provided by embodiments have been described with reference to illustrative examples involving on-line gaming, wedding invitations and system operation based on known work-related data such as a work e-mail address, embodiments may be utilized in various other online computing system environments.

For example, embodiments may be utilized with an online social networking website such as FACEBOOK social networking website. In these embodiments, a user of a social networking website is checking her account on-line social networking website account from an IPHONE mobile telephone. She sees that an online friend will have a birthday in a few days. The friend lives on the other side of the country and they have never met. The user opens an application of embodiments for sending mailers to other users of FACEBOOK social networking website. The online friend's address is in database 140 of embodiments. The user selects a birthday card, customizes the text of the card, types a happy birthday message to the friend, sends the mailer request, and pays for the transaction using her account with ITUNES on-line music service. Embodiments generate the birthday card, address the envelope with the online friend's physical mail address, and deliver the birthday card to the US Postal Service with sufficient postage to be delivered.

As yet another example, user of a social networking service wants to send out his holiday greeting cards. He opens a user interface to the Mailer System from his networking service account. He selects a “Happy Holidays” card, uploads a picture of himself and his cat, and uploads a black and white image of his signature. The user selects all of his networking service friends and sends a command to the system to send a card to each friend. The user has the physical address for some of his friends but not others. For those friends who have not uploaded their physical address, the user inputs a physical address. The user types a personal message to each friend. Embodiments generate the “Happy Holidays” card with the picture of the user and his cat at the mail shop closest to the physical address of each addressee. Each card is personalized for each addressee, and is “signed” in blue ink with the image of the user's signature. The mail system addresses each card with the physical address selected by the user, and delivers the card to the postal service with sufficient postage for delivery.

As a further example, a user of MYSPACE on-line social networking website or other online social networking website user wishes to express her friendship to another member of the site. This person opens the application for embodiments and sees the other person has their address in the data base. Embodiments provide a catalog of available goods for friendship, camaraderie, romance, etc. The sending user selects a bottle of wine, and embodiments alert her to the fact that this category of gift is not accepted for this receiver's profile. Unknown to the sender, the receiver lives in a jurisdiction where alcohol is prohibited. The system suggests alternatives. The sender then selects a box of chocolate, and the system selects the closest physical seller to the receiver of the box of chocolate help minimize cost and time of shipment and the goods are sent to the receiver without revealing any personal information.

As another example, in furtherance of embodiments related to on-line gaming as described previously, a gamer playing WORLD OF WARCRAFT on-line game in a guild learns some other guild members are husband and wife. The gamer learns that the husband and wife are celebrating an anniversary in a few days. The gamer opens a user interface to system embodiments, selects the avatar names of the husband and wife, selects a “Happy Anniversary” card, and sends a command to the system to send the card to the husband and wife wishing them happy anniversary. Unknown to the gamer is that the husband and wife live in Australia. The system generates the happy anniversary card in Australia using the real names of the husband and wife, addresses the card with the physical home address of the husband and wife in Australia, and delivers the card to the postal service with sufficient postage for delivery.

As a further example, members of a guild on the GUILDWARS online game want to coordinate a joint attack using a technique described in a book available from an online shopping service such as AMAZON on-line shopping service. The guild president opens the mailer system application on his computer and orders the desired book for each guild member even though he only knows their online name. The mailer system places the order for the books and has them shipped to the real name and address of each member while charging the senders account for the purchases without revealing the true identity of the members.

Further, a school class is arranging for a 20-year reunion. The class representative opens a user interface to the system and locates the class members, such as a FACEBOOK online social networking website page for class members. The class representative uploads an announcement of the weekend activities to the system, along with the addresses for the class members gathered at the 10-year reunion. The system checks the addresses and find many class members have moved. The system places the correct address on the announcements and delivers the announcements to the postal service with sufficient postage for delivery. The system notifies the class representative of the incorrect address but does not provide the new address unless authorized to do so by the receiving class member. In one example, a class member has set the Permissions to allow all members of the class page of FACEBOOK on-line social networking website to view their physical address, phone number and e-mail.

As another example, a sender who is a member of a dating website, such as EHARMONY, MATCH and ZOOSK online dating services, wishes to send a card and flowers for Valentine's Day to several of the other members with whom he has been communicating. One of the receiving members does not allow for receiving non-mailer goods. The sender selects different flowers for each receiver who allows non-mailer goods, and also personalizes a card for each. For the first receiving member, the sender only sends a card. The system generates the mailers, matches the mailers with the goods if needed, and causes the mailers and goods to be delivered to the appropriate receiver. The privacy and anonymity provided by embodiments, particularly for a receiving user and online stalking concerns, by preventing other users from knowing a member's true identity and residence address.

As another example, a member of an online Christian fellowship group wants to share a message given by one of his favorite speakers. He opens the mailer system interface and directs the purchase of the desired material from a web site. He then selects the recipients as his study group which only has online identities. The system makes the purchase and directs the online source of the material to send it to the real name and address of each selected recipient.

Another example involves a member of an online political forum wants to send a book and movie he found on a topic of discussion to another member. He opens the system interface, locates the goods, and directs the online purchase. The system sends the goods to the receiver. The receiver doesn't care for the subject and simply returns the goods to the retailer for a refund to the sender.

Embodiments may also be used in adult dating websites. An adult dating website member wants to send a gift to another member of the same website. The sender opens the system interface and finds the online identity of the receiver listed. She also finds that gifts of an intimate nature are allowed by receiver to be received. A purchase is made at a retail website and the gift is shipped to the real name and address of the receiver without revealing the true identity of either of the members.

As another example, a sporting goods store wants to increase sales. The store joins a shipping system group “local Baseball Players Association.” The store sends all members of the group a coupon book good for discounts on baseball equipment. The store does not learn the real identity or address of the group members.

In a further example, a sender wants to communicate with a receiver by hand written letters. The sender writes out a letter and addresses it with uniquely identifying information as found in system embodiments. The sender mails the letter to the system, and the system forwards the letter to the receiver.

As another example, an on-line book club is reading an out of print book. One of the members has several copies, while other members are unable to find a copy locally. The Sender packages each extra copy of the book and addresses it with uniquely identifying information as found in the system. She sends the books to the system, and the system forwards each book to the identified receiver.

Networked computing systems of embodiments may be accessed directly by a user computing device, or accessed or through various other online computing system environments, such as by clicking a link or icon in a page of a social networking website or in a screen of an on-line game or other online application, examples of which are described above.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, modifications and variations are possible in view of the above teachings. The embodiments were chosen and described in order to best explain the principles of the invention and its practical applications. They thereby enable others skilled in the art to best utilize the invention and various embodiments with various modifications as are suited to the particular use contemplated.

What is claimed is:

1. A system operable to protect personal data in an on-line and a physical world in which the personal data is used for physical world communications, the system comprising:
a web server including a memory and a processor, the web server in communication with one or more users' computing devices through one or more networks;
a data privacy application comprising instructions stored in the memory of the web server and executable by the processor of the web server; and
a database in communication with the web server and including data structures for users of the data privacy application, wherein
the data privacy application is configured to:
receive personal data of users of the data privacy application from the users' computing devices, the personal data including one or more physical mailing addresses of each user in the physical world;
store the users' personal data in the data structures of the database;
receive user input of permissions or rules concerning use of that user's personal data by other users of the data privacy application, and update the data structures with the permissions or rules, wherein a first user, as a receiving user, specifies a preauthorized permission or rule for a second user, as a sending user, to utilize the first user's personal data hosted by the database, and to allow the second user to communicate with the first user in the physical world, the preauthorized permission or rule being specified and stored in the database prior to the second user requesting to communicate with the first user in the physical world; and
receive a request from the second user's computing device to send a physical mailer to the first user in the physical world, wherein the request includes identification information that uniquely identifies the first user and that is known and provided by the second user; and
in response to the second user's request, the data privacy application being further configured to
identify personal data of the first user associated with the identification information in a data structure of the database and identify a preauthorized permission or rule specified by the first user for allowing the second user to communicate with the first user in the physical world using the personal data, and
retrieve or receive mailer data, wherein the physical mailer is generated based on the mailer data and the first user's personal data in accordance with the identified preauthorized permission or rule input by the first user so that the physical mailer is sent to the first user in the physical world without the second user being provided with the first user's personal data.

2. The system of claim 1, further comprising a printer in communication with the data privacy application, wherein the data privacy application is further configured to transmit the mailer data and the first user's personal data including the physical mailing address of the first user through the one or more networks to the printer, and the printer is configured to generate the physical mailer based on the received mailer data and the first user's personal data.

3. The system of claim 2, further comprising a mailer modification system in communication with the printer, wherein the mailer modification system is configured to cut the physical mailer to size for insertion into an envelope or carrier.

4. The system of claim 3, further comprising a packaging system in communication with the mailer modification system, wherein the packaging system is configured to insert a cut physical mailer into the envelope or carrier.

5. The system of claim 4, further comprising a postage system in communication with the packaging system, wherein the postage system is configured to apply postage to the envelope or carrier.

6. The system of claim 1, wherein the physical mailer is selected from the group consisting of a greeting card and a postcard.

7. The system of claim 1, wherein the second user never physically possesses the physical mailer.

8. The system of claim 1, wherein the data privacy application is configured to provide the first user with controllable physical world anonymity for communications involving the first user's personal data in the physical world.

9. The system of claim 1, wherein the first user's personal data further includes a real name of the first user, wherein the physical mailer is generated based on the mailer data, the first user's real name, the first user's physical address, and in accordance with the identified preauthorized permission or rule, so that the physical mailer is sent to the first user in the physical world without the second user being provided with the first user's real name or physical address.

10. The system of claim 1, wherein the personal data further includes a physical mailing address of the second user, the physical mailer includes a return address, and the return address of the physical mailer does not include the physical mailing address of the second user.

11. The system of claim 10, wherein the return address is printed on the physical mailer, and the return address is an address or location of a host of the system.

12. The system of claim 10, wherein the personal data of the second user further includes a real name of the second user, wherein the return address of the physical mailer does not include the real name of the second user.

13. The system of claim 1, wherein the data privacy application is further configured to transmit an electronic version of the physical mailer to a computing device of the first user.

14. The system of claim 1, wherein the data privacy application is further configured to:
identify a mailing facility that is closer to the physical address of the first user than a location of the system; and
transmit the mailer data and the first user's personal data through a network to a computing device of the mailing facility, wherein the physical mailer is generated remotely relative to the system and remotely relative to the second user based on the mailer data and the first user's personal data received by the mailing facility.

15. The system of claim 1, wherein the data privacy application is further configured to determine that the identification information provided by the second user is not included in a data structure of the database.

16. The system of claim 1, wherein
the first user and the second user utilize the same online application or website,
the personal data of the first user includes a real name of the first user and a physical mailing address of the first user, and
the identification information provided by the second user to locate the first user in the data privacy application is a username or screen name of the first user utilized in the online application or website.

17. The system of claim 16, wherein the online application or website is an on-line game or social networking website.

18. The system of claim 1, wherein one or more preauthorized permissions or rules identifies more than one user as being an approved user that is preauthorized to send one or more physical mailer to the first user.

19. The system of claim 1, wherein one or more preauthorized permissions or rules identifies one or more users that are blocked or prevented from sending a physical mailer to the first user.

20. A computer program product comprising a computer program carrier comprising non-transitory computer readable media embodying one or more programmed instructions of a data privacy application operable to protect personal data in an on-line and a physical world in which the personal data is used for physical world communications, the data privacy application comprising instructions stored in a memory of a web server in communication with one or more users' computing devices through one or more networks and in communication with a database comprising data structures for users of the data privacy application, the programmed instructions of the data privacy application being executable by a processor of the web server to
receive personal data of users of the data privacy application from the users' computing devices, the personal data including one or more physical mailing addresses of each user in the physical world;
store the users' personal data in the data structures of the database;
receive user input of permissions or rules concerning use of that user's personal data by other users of the data privacy application, and update the data structures with the permissions or rules, wherein a first user, as a receiving user, specifies a preauthorized permission or rule for a second user, as a sending user, to utilize the first user's personal data hosted by the database, and to allow the second user to communicate with the first user in the physical world, the preauthorized permission or rule being specified and stored in the database prior to the second user requesting to communicate with the first user in the physical world; and
receive a request from the second user's computing device to send a physical mailer to the first user in the physical world, wherein the request includes identification information that uniquely identifies the first user and that is known and provided by the second user; and
in response to the second user's request, the data privacy application being further configured to
identify personal data of the first user associated with the identification information in a data structure of the database and identify a preauthorized permission or rule specified by the first user for allowing the second user to communicate with the first user in the physical world using the personal data, and
retrieve or receive mailer data, wherein the physical mailer is generated based on the mailer data and the first user's personal data in accordance with the identified preauthorized permission or rule input by the first user so that the physical mailer is sent to the first user in the physical world without the second user being provided with the first user's personal data.
